(19) United States
(12) Patent Application Publication
(10) Pub. No.: US 2026/0170577 A1
(43) Pub. Date: Jun. 18, 2026

(54) METHOD FOR ZONAL JOINT PEAK SHAVING DISPATCH CONSIDERING DAY-AHEAD OPERATION SECURITY DOMAIN, DEVICE, MEDIUM, AND PRODUCT

(71) Applicants: North China Electric Power University, Beijing (CN); State Grid Gansu Electric Power Company, Lanzhou City (CN)

(72) Inventors: Nian LIU, Beijing (CN); Kai JIANG, Beijing (CN); Jiye WANG, Lanzhou City (CN); Kunyu WANG, Lanzhou City (CN); Diangang HU, Lanzhou City (CN); Wen TANG, Lanzhou City (CN); Zongyang LIU, Lanzhou City (CN); Zhewei ZHANG, Lanzhou City (CN); Lei WANG, Beijing (CN)

(21) Appl. No.: 19/401,174

(22) Filed: Nov. 25, 2025

(30) Foreign Application Priority Data
Dec. 17, 2024 (CN) 202411854366.5

(51) Int. Cl. G06Q 50/06; G06F 17/11; G06N 3/044; G06N 3/08; G06Q 10/04

(52) U.S. Cl. CPC G06Q 50/06; G06F 17/11; G06N 3/044; G06N 3/08; G06Q 10/04

(57) ABSTRACT

Provided are a method for zonal joint peak shaving dispatch considering a day-ahead operation security domain, a device, a medium, and a product. The method includes: solving a dimensionality-reduced overall day-ahead dispatch model to obtain an overall day-ahead dispatch plan; constructing a day-ahead operation security domain based on the overall day-ahead dispatch plan and local loads of zones, determining upward regulation capabilities and downward regulation capabilities under different unit operating points within the day-ahead operation security domain, and performing clustering and screening to obtain zonal dispatch capabilities; determining a zonal day-ahead dispatch plan for each zone based on the overall day-ahead dispatch plan; constructing and solving a peak shaving demand allocation model to obtain a zonal peak shaving demand for each zone; and inputting the zonal day-ahead dispatch plan and the zonal peak shaving demand into a zonal plan correction model, to obtain a corrected zonal day-ahead dispatch plan.

### CROSS REFERENCE TO RELATED APPLICATION

This patent application claims the benefit and priority of Chinese Patent Application No. 202411854366.5, filed with the China National Intellectual Property Administration on Dec. 17, 2024, the disclosure of which is incorporated by reference herein in its entirety as part of the present application.

### TECHNICAL FIELD

The present disclosure relates to the technical field of power dispatch, and in particular to a method for zonal joint peak shaving dispatch considering a day-ahead operation security domain, a device, a medium, and a product.

### BACKGROUND

With the continuous development of power systems and the high-proportion integration of new energy sources, power systems are facing complex large-scale dispatch problems under intensified uncertainty on both the source and load sides. Traditional dispatch methods face issues such as high computational complexity, slow optimization speed, and low computational accuracy when dealing with large-scale dispatch problems. Furthermore, recalculating a day-ahead dispatch plan, which requires substantial computational resources, to accommodate new peak shaving demands is inefficient.

### SUMMARY

An objective of the present disclosure is to provide a method for zonal joint peak shaving dispatch considering a day-ahead operation security domain, a device, a medium, and a product, to solve the problem that a day-ahead dispatch plan cannot be quickly corrected when facing new peak shaving demands.

To achieve the above objective, the present disclosure provides the following solutions.

According to a first aspect, the present disclosure provides a method for zonal joint peak shaving dispatch considering a day-ahead operation security domain, including:
constructing an overall day-ahead dispatch model for a current dispatch region, where the overall day-ahead dispatch model includes: an overall day-ahead dispatch objective function and overall constraints;
performing dimensionality reduction processing on the overall day-ahead dispatch model of the current dispatch region by using a model dimensionality reduction strategy, to obtain a dimensionality-reduced overall day-ahead dispatch model for the current dispatch region, where the model dimensionality reduction strategy includes: a time period merging strategy and a constant-on-constant-off thermal power unit identification strategy;
solving the dimensionality-reduced overall day-ahead dispatch model of the current dispatch region by using an Adaptive Binary Salp Swarm Algorithm (ABSSA), to obtain an overall day-ahead dispatch plan for the current dispatch region;
constructing a day-ahead operation security domain for the current dispatch region based on the overall day-ahead dispatch plan of the current dispatch region and local loads of zones in the current dispatch region, and determining upward regulation capabilities and downward regulation capabilities under different unit operating points within the day-ahead operation security domain;
performing clustering and screening on the upward regulation capabilities and the downward regulation capabilities under the different unit operating points by using a double k-means clustering algorithm, to obtain zonal dispatch capabilities under the overall day-ahead dispatch plan of the current dispatch region;
determining a zonal day-ahead dispatch plan for each zone in the current dispatch region based on the overall day-ahead dispatch plan of the current dispatch region;
constructing a peak shaving demand allocation model for the current dispatch region based on the zonal dispatch capability of each zone in the current dispatch region;
solving the peak shaving demand allocation model of the current dispatch region by using an Arctic Puffin Optimization (APO) algorithm, to obtain a zonal peak shaving demand for each zone in the current dispatch region; and
inputting the zonal day-ahead dispatch plan and the zonal peak shaving demand of each zone in the current dispatch region into a zonal plan correction model, to obtain a corrected zonal day-ahead dispatch plan for the corresponding zone, where the zonal plan correction model is obtained by training a Bidirectional Gated Recurrent Unit (BiGRU)-Attention neural network.

Optionally, a process of determining the zonal plan correction model includes:
generating zonal day-ahead dispatch plans and zonal peak shaving demands for each zone of a plurality of training regions by using a random function;
constructing a zonal day-ahead dispatch correction model for each training dispatch region based on an overall day-ahead dispatch plan of each training dispatch region and the zonal peak shaving demand of each zone;
solving the zonal day-ahead dispatch correction model of each training dispatch region by using an Eel and Grouper Optimizer (EGO) algorithm, to obtain a corrected zonal day-ahead dispatch plan for each training dispatch region;
constructing the BiGRU-Attention neural network based on a forward gated recurrent unit, a backward gated recurrent unit, and an attention mechanism; and
training the BiGRU-Attention neural network by using the zonal day-ahead dispatch plan and the zonal peak shaving demand of each zone of each training dispatch region as input, and the corrected zonal day-ahead dispatch plan of the corresponding zone as output, to obtain the zonal plan correction model.

Optionally, the overall day-ahead dispatch objective function includes:

$$\begin{matrix}{C}_{total}^{a h e a d} = {C}_{g} + {C}_{loss} + {C}_{e s} + {C}_{dm} ; \\ \{ \begin{matrix}{C}_{g} = & {C}_{g , coal} + {C}_{g , on} + {C}_{g , r v} \\ = & {\sum }_{i = 1}^{{N}_{g}} {\sum }_{t = 1}^{T} {u}_{i , t}^{g} [ {a}_{i} {( {p}_{i , t}^{g} )}^{2} + {b}_{i} {p}_{i , t}^{g} + {c}_{i} ] + {\sum }_{i = 1}^{{N}_{g}} {\sum }_{t = 1}^{T} {c}_{i , t}^{g , on} [ {u}_{i , t}^{g} ( 1 − {u}_{i , t}^{g} ) ] + \\ & {\sum }_{i = 1}^{{N}_{g}} {\sum }_{t = 1}^{T} [ {c}_{i , t}^{g , r v} ( {R}_{i , t}^{g +} + {R}_{i , t}^{g −} ) ] \\ {C}_{loss} = & {\sum }_{i = 1}^{{N}_{w}} {\sum }_{t = 1}^{T} [ {c}_{i , t}^{w} ( {p}_{i , t}^{w f} − {p}_{i , t}^{w} ) ] + {\sum }_{i = 1}^{{N}_{p}} {\sum }_{t = 1}^{T} [ {c}_{i , t}^{p} ( {p}_{i , t}^{p f} − {p}_{i , t}^{p} ) ] \\ {C}_{e s} = & {\sum }_{i = 1}^{{N}_{e s}} {\sum }_{t = 1}^{T} [ {c}_{i , t}^{e s} ( {p}_{i , t}^{e s , d} + {p}_{i , t}^{e s , c} ) ] \\ {C}_{dm} = & {\sum }_{i = 1}^{{N}_{l}} {\sum }_{t = 1}^{T} ( {c}_{i , t}^{d m} {p}_{i , t}^{d m} )\end{matrix}\end{matrix}$$

where

$${C}_{total}^{a h e a d}$$

is a total day-ahead dispatch cost; C_{g} is a thermal power cost; Cₗₒₛₛ is a curtailment cost; Cₑₛ is an energy storage operation cost; C_{dm} is a demand response cost; C_{g,coal} is a coal consumption cost; C_{g,on} is a start-stop cost; C_{g,rv} is a spinning reserve cost; N_{g} is the number of thermal power units in a dispatch region; T is a dispatch period;

$${u}_{i , t}^{g}$$

is a start-stop state variable of an i-th thermal power unit at time t; aᵢ, bᵢ, and cᵢ are coal consumption coefficients of thermal power;

$${p}_{i , t}^{g}$$

is actual output of the i-th thermal power unit at time t;

$${c}_{i , t}^{g , on}$$

is a single start-stop cost of the i-th thermal power unit at time t;

$${c}_{i , t}^{g , rv}$$

is a spinning reserve capacity cost coefficient of the i-th thermal power unit at time t;

$${R}_{i , t}^{g +}$$

is a positive spinning reserve capacity of the i-th thermal power unit at time t;

$${R}_{i , t}^{g -}$$

is a negative spinning reserve capacity of the i-th thermal power unit at time t; N_{w} is the number of wind power units in the dispatch region;

$${c}_{i , t}^{w}$$

is a curtailment cost coefficient of an i-th wind power unit at time t;

$${p}_{i , t}^{wf}$$

is predicted output of the i-th wind power unit at time t;

$${p}_{i , t}^{w}$$

is actual output of the i-th wind power unit at time t; Nₚ is the number of photovoltaic units in the dispatch region;

$${c}_{i , t}^{p}$$

is a curtailment cost coefficient of an i-th photovoltaic unit at time t;

$${p}_{i , t}^{pf}$$

is predicted output of the i-th photovoltaic unit at time t;

$${p}_{i , t}^{p}$$

is actual output of the i-th photovoltaic unit at time t; Nₑₛ is the number of electrochemical energy storage systems in the dispatch region;

$${c}_{i , t}^{es}$$

is an operation cost per unit power of an i-th electrochemical energy storage system at time t;

$${p}_{i , t}^{es , d}$$

is a discharging power of the i-th electrochemical energy storage system at time t;

$${p}_{i , t}^{es , c}$$

is a charging power of the i-th electrochemical energy storage system at time t; Nₗ is the number of demand responses in the dispatch region;

$${c}_{i , t}^{dm}$$

is a cost coefficient of an i-th demand response at time t; and

$${p}_{i , t}^{dm}$$

is an i-th actual demand response at time t.

Optionally, the overall constraints include: wind and photovoltaic safe operating range constraints, technical output upper and lower limits and ramp rate constraints of the thermal power units, energy storage system operation constraints, power balance constraints, line power flow security constraints and tie-line constraints, system positive and negative spinning reserve constraints, and demand response model constraints;
the wind and photovoltaic safe operating range constraints include:

$$\{ \begin{matrix}{p}_{i , t}^{w , min} \leq {p}_{i , t}^{w} \leq {p}_{i , t}^{wf} \leq {p}_{i , t}^{w , max} \\ {p}_{i , t}^{p , min} \leq {p}_{i , t}^{p} \leq {p}_{i , t}^{pf} \leq {p}_{i , t}^{p , max}\end{matrix} ;$$

where

$${p}_{i , t}^{w , min}$$

is minimum output of the i-th wind power unit at time t;

$${p}_{i , t}^{w , m ax}$$

is maximum output of the i-th wind power unit at time t;

$${p}_{i , t}^{p , m i n}$$

is minimum output of the i-th photovoltaic unit at time t; and

$${p}_{i , t}^{p , m ax}$$

is maximum output of the i-th photovoltaic unit at time t;
the technical output upper and lower limits and ramp rate constraints of the thermal power units include:

$${u}_{i , t}^{g} {p}_{i , t}^{g , m i n} \leq {p}_{i , t}^{g} \leq {u}_{i , t}^{g} {p}_{i , t}^{w , ma x} ;$$

$$\{ \begin{matrix}{p}_{i , t + 1}^{g} - {p}_{i , t}^{g} \leq {Q}_{i}^{g , up} {u}_{i , t}^{g} + {p}_{i , t + 1}^{g , m i n} ( {u}_{i , t + 1}^{g} - {u}_{i , t}^{g} ) + {p}_{i , t + 1}^{g , ma x} ( 1 - {u}_{i , t + 1}^{g} ) \\ {p}_{i , t}^{g} - {p}_{i , t + 1}^{g} \leq {Q}_{i}^{g , down} {u}_{i , t + 1}^{g} - {p}_{i , t + 1}^{g , m i n} ( {u}_{i , t + 1}^{g} - {u}_{i , t}^{g} ) + {p}_{i , t + 1}^{g , ma x} ( 1 - {u}_{i , t}^{g} )\end{matrix}$$

where

$${p}_{i , t}^{g , m i n}$$

is minimum output of the i-th thermal power unit at time t;

$${p}_{i , t}^{g , ma x}$$

is maximum output of the i-th thermal power unit at time t;

$${P}_{i , t + 1}^{g}$$

is actual output of the i-th thermal power unit at time t+1;

$${Q}_{i}^{g , up}$$

is a ramping-up power limit of the i-th thermal power unit;

$${p}_{i , t + 1}^{g , m i n}$$

is minimum output of the i-th thermal power unit at time t+1;

$${u}_{i , t + 1}^{g}$$

is a start-stop state variable of the i-th thermal power unit at time t+1;

$${p}_{i , t + 1}^{g , ma x}$$

is maximum output of the i-th thermal power unit at time t+1; and

$${Q}_{i}^{g , down}$$

is a ramping-down power limit of the i-th thermal power unit;
the energy storage system operation constraints include:

$$\{ \begin{matrix}{p}_{i , t}^{es , m i n} \leq {p}_{i , t}^{es , c} , {p}_{i , t}^{es , d} \leq {p}_{i , t}^{es , m ax} \\ {SoC}_{i , t + 1}^{e s} = {SoC}_{i , t}^{e s} + [ ( {η}_{i , t}^{es , c} {p}_{i , t}^{es , c} - {p}_{i , t}^{es , d} / {η}_{i , t}^{es , d} ) Δ t ] / {E}_{i}^{e s} \\ {SoC}_{i , t}^{es , m i n} \leq {SoC}_{i , t}^{e s} \leq {SoC}_{i , t}^{e s , m ax}\end{matrix}$$

where

$${p}_{i , t}^{es , m i n}$$

is a lower power limit of the i-th electrochemical energy storage system at time t;

$${p}_{i , t}^{e s , m ax}$$

is an upper power limit of the i-th electrochemical energy storage system at time t;

$${SoC}_{i , t + 1}^{es}$$

is a state of charge of the i-th electrochemical energy storage system at time t+1;

$${SoC}_{i , t}^{e s}$$

is a state of charge of the i-th electrochemical energy storage system at time t;

$${η}_{i , t}^{es , c}$$

is charging efficiency of the i-th electrochemical energy storage system at time t;

$${η}_{i , t}^{es , d}$$

is discharging efficiency of the i-th electrochemical energy storage system at time t; Δt is a t-th dispatch time period;

$${E}_{i}^{e s}$$

is rated energy of the i-th electrochemical energy storage system;

$${SoC}_{i , t}^{es , min}$$

is a low state of charge of the i-th electrochemical energy storage system at time t; and

$${SoC}_{i , t}^{es , max}$$

is a high state of charge of the i-th electrochemical energy storage system at time t;
the power balance constraints include:

$${{\sum }_{i = 1}}^{Ng} {p}_{i , t}^{g} + {{\sum }_{i = 1}}^{Nw} {p}_{i , t}^{w} + {{\sum }_{i = 1}}^{Np} {p}_{i , t}^{p} + {{\sum }_{i = 1}}^{Nes} ( {p}_{i , t}^{es , d} - {p}_{i , t}^{es , c} ) = {{\sum }_{i = 1}}^{Nl} ( {p}_{i , t}^{load} - {p}_{i , t}^{d m} ) + {{\sum }_{j = 1}}^{NT} {p}_{j , t}^{n t}$$

where

$${p}_{i , t}^{load}$$

is an i-th local load at time t;

$${p}_{j , t}^{n t}$$

is an outgoing load of a j-th tie-line at time t; and NT is the number of tie-lines with outgoing loads;
the line power flow security constraints and the tie-line constraints include:

$$- {P}_{l}^{max} \leq {p}_{l , t}^{k} \leq {p}_{l}^{max} ;$$

$$- {P}_{j , t}^{n t , max} \leq {p}_{j , t}^{n t} \leq {p}_{j , t}^{n t , max} ;$$

where

$${P}_{l}^{max}$$

is an upper power limit of an l-th line;

$${p}_{l , t}^{k}$$

is an actual power of the l-th line at time t;

$${P}_{j , t}^{n t , max}$$

is an upper power limit of the j-th tie-line; and

$${p}_{j , t}^{n t}$$

is an actual power of the j-th tie-line;
the system positive and negative spinning reserve constraints include:

$$\{ \begin{matrix}{\sum }_{i = 1}^{{N}_{g}} min \{ {p}_{i , t}^{g , max} - {p}_{i , t}^{g} , {Q}_{i}^{g , up} \} \geq {R}_{t}^{g +} \\ {\sum }_{i = 1}^{{N}_{g}} min \{ {p}_{i , t}^{g} - {p}_{i , t}^{g , min} , {Q}_{i}^{g , down} \} \geq {R}_{t}^{g -}\end{matrix}$$

$$\{ \begin{matrix}{R}_{t}^{g +} = {\sum }_{i = 1}^{{N}_{g}} {R}_{i , t}^{g +} \geq {\partial }^{l +} {\sum }_{i = 1}^{{N}_{l}} {p}_{i , t}^{load} + {\partial }^{w +} {\sum }_{i = 1}^{{N}_{w}} {p}_{i , t}^{w} + {\partial }^{p +} {\sum }_{i = 1}^{{N}_{p}} {p}_{i , t}^{p} \\ {R}_{t}^{g -} = {\sum }_{i = 1}^{{N}_{g}} {R}_{i , t}^{g -} \geq {\partial }^{l -} {\sum }_{i = 1}^{{N}_{l}} {p}_{i , t}^{load} + {\partial }^{w -} {\sum }_{i = 1}^{{N}_{w}} {p}_{i , t}^{w} + {\partial }^{p -} {\sum }_{i = 1}^{{N}_{p}} {p}_{i , t}^{p}\end{matrix}$$

where

$${R}_{t}^{g +}$$

is a total positive spinning reserve capacity at time t;

$${R}_{t}^{g -}$$

is a total negative spinning reserve capacity at time t; ∂^{w+} is an upward reserve coefficient for the wind power units; ∂^{p+} is an upward reserve coefficient for the photovoltaic units; ∂^{l+} is an upward reserve coefficient for the local loads; ∂^{w-} is a downward reserve coefficient for the wind power units; ∂^{p-} is a downward reserve coefficient for the photovoltaic units; and ∂^{l-} is a downward reserve coefficient for the local loads;
the demand response model constraints include:

$${p}_{i , min}^{d m} \leq {p}_{i , t}^{d m} \leq {k}_{i , max}^{d m} {p}_{i , ma x}^{load} ;$$

where

$${p}_{i , m i n}^{d m}$$

is a lower limit value of the i-th demand response;

$${p}_{i , ma x}^{load}$$

is a day-ahead peak value of the i-th local load; and

$${k}_{i , m ax}^{d m}$$

is a maximum coefficient of the i-th demand response.

Optionally, the day-ahead operation security domain includes:

$$Ω = \{ x \vert \begin{matrix}f ( x , y ) = 0 \\ g ( x , y , z ) \leq 0 \\ k ( x , y ) \leq 0\end{matrix} \} ;$$

where Ω is a set of all unit operating points in a zone; x is a key decision vector corresponding to all the unit operating points in the zone during the dispatch period; z is a discrete variable of a wind-photovoltaic-thermal-energy storage system in the zone; y is a vector formed by other system variables; f(x,y)=0 is a power flow equality constraint; g(x,y,z)≤0 is a unit commitment constraint set, including: the wind and photovoltaic safe operating range constraints, the technical output upper and lower limits and ramp rate constraints of the thermal power units, the energy storage system operation constraints, and the demand response model constraints; and k(x,y)≤0 is a security constraint set;
the power flow equality constraint is expressed as follows:

$${\sum }_{i = 1}^{{N}_{g , x}} {R}_{i , t}^{g} + {\sum }_{i = 1}^{{N}_{w , x}} {p}_{i , t}^{w} + {\sum }_{i = 1}^{{N}_{p , x}} {p}_{i , t}^{p} + {\sum }_{i = 1}^{{N}_{es , x}} ( {p}_{i , t}^{es , d} - {p}_{i , t}^{es , c} ) = {\sum }_{i = 1}^{{N}_{l , x}} ( {p}_{i , t}^{load} - {p}_{i , t}^{d m} ) + {\sum }_{j = 1}^{{NT}_{x}} {p}_{j , t}^{n t}$$

where N_{g,x} is the number of thermal power units in an x-th zone; N_{w,x} is the number of wind power units in the x-th zone; N_{p,x} is the number of photovoltaic units in the x-th zone; N_{es,x} is the number of electrochemical energy storage systems in the x-th zone; N_{l,x} is the number of local loads in the x-th zone; and NTₓ is the number of tie-lines in the x-th zone;
the security constraint set is expressed as follows:

$$\{ \begin{matrix}- {p}_{l , x}^{m ax} \leq {p}_{l , x , t}^{k} \leq {p}_{l , x}^{m ax} \\ - {p}_{x , j , t}^{n t , m ax} \leq {p}_{x , j , t}^{n t} \leq {p}_{x , j , t}^{n t , m ax} \\ {\sum }_{i = 1}^{{N}_{g , x}} min \{ {p}_{i , t}^{g , m ax} - {p}_{i , t}^{g} , {Q}_{i}^{g , up} \} \geq {R}_{t , x}^{g +} \\ {\sum }_{i = 1}^{{N}_{g , x}} min \{ {p}_{i , t}^{g} - {p}_{i , t}^{g , m i n} , {Q}_{i}^{g , down} \} \geq {R}_{t , x}^{g -} \\ {R}_{t , x}^{g +} \geq {\partial }^{l +} {\sum }_{i = 1}^{{N}_{l , x}} {p}_{i , t}^{load} + {\partial }^{w +} {\sum }_{i = 1}^{{N}_{w , x}} {p}_{i , t}^{w} + {\partial }^{p +} {\sum }_{i = 1}^{{N}_{p , x}} {p}_{i , t}^{p} \\ {R}_{t , x}^{g -} \geq {\partial }^{l -} {\sum }_{i = 1}^{{N}_{l , x}} {p}_{i , t}^{load} + {\partial }^{w -} {\sum }_{i = 1}^{{N}_{w , x}} {p}_{i , t}^{w} + {\partial }^{p -} {\sum }_{i = 1}^{{N}_{p , x}} {p}_{i , t}^{p}\end{matrix}$$

where

$${p}_{l , x , t}^{k}$$

is an actual power of an l-th line in the x-th zone at time t;

$${P}_{l , x}^{m ax}$$

is an upper power limit of the l-th line in the x-th zone;

$${p}_{x , j , t}^{n t}$$

is an actual power of a j-th tie-line in the x-th zone at time t;

$${P}_{x , j , t}^{n t , m ax}$$

is an upper power limit of the j-th tie-line in the x-th zone at time t;

$${R}_{t , x}^{g +}$$

is a positive spinning reserve capacity of the x-th zone at time t; and

$${R}_{t , x}^{g -}$$

is a negative spinning reserve capacity of the x-th zone at time t.

Optionally, a calculation formula for the upward regulation capability includes:

$${T}_{x , t}^{+} = {\sum }_{i = 1}^{{N}_{g , x}} [ min \{ {p}_{i , t}^{g , max} - {p}_{i , t}^{g} , {Q}_{i}^{g , up} \} - {R}_{i , t}^{g +} ] + {\sum }_{i = 1}^{{N}_{l , x}} [ {k}_{i , max}^{dm} {p}_{i , max}^{load} - {p}_{i , t}^{dm} ] + {\sum }_{i = 1}^{{N}_{es , x}} min \{ [ {p}_{i , t}^{es , max} + ( {p}_{i , t}^{es , d} - {p}_{i , t}^{e s , c} ) ] , [ ( {SoC}_{i , t}^{es , max} - {SoC}_{i , t}^{es} ) {E}_{i}^{es} + ( {p}_{i , t}^{es , d} - {p}_{i , t}^{es , c} ) ] \}$$

a calculation formula for the downward regulation capability includes:

$${T}_{x , t}^{-} = {\sum }_{i = 1}^{{N}_{g , x}} [ min \{ {p}_{i , t}^{g} - {p}_{i , t}^{g , min} , {Q}_{i}^{g , down} \} - {R}_{i , t}^{g -} ] + {\sum }_{i = 1}^{{N}_{l , x}} [ {p}_{i , t}^{dm} - {p}_{i , min}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es} - {SoC}_{i , t}^{es , min} ) {E}_{i}^{es} + ( {p}_{i , t}^{es , d} - {p}_{i , t}^{es , c} ) ] \}$$

where

$${T}_{x , t}^{+}$$

is an upward regulation capability of the x-th zone at time t; and

$${T}_{x , t}^{-}$$

is a downward regulation capability of the x-th zone at time t.

Optionally, the peak shaving demand allocation model includes:

$$\{ \begin{matrix}{\sum }_{j = 1}^{N T} {p}_{j , t}^{nt +} = {\sum }_{x = 1}^{{N}_{x}} {p}_{x , t}^{T} \\ - {P}_{l , x}^{a , max} \leq {\sum }_{x = 1}^{{N}_{x}} {G}_{l - x} {p}_{x , t}^{T} - {\sum }_{j = 1}^{N T} {G}_{l - j} {p}_{j , t}^{nt +} + {p}_{t}^{10} \leq {P}_{l , x}^{a , max} \\ - {P}_{j , t}^{nt , max} \leq {p}_{j , t}^{nt} + {p}_{j , t}^{nt +} \leq {P}_{j , t}^{nt , max} \\ - {T}_{x , t , f}^{-} \leq {p}_{x , t}^{T} \leq {T}_{x , t , max}^{+} or - {T}_{x , t , max}^{-} \leq {p}_{x , t}^{T} \leq {T}_{x , t , f}^{+}\end{matrix}$$

$$\{ \begin{matrix}{T}_{x , t , m}^{-} = {u}_{x , t}^{m} {T}_{x , t , f}^{-} + ( 1 - {u}_{x , t}^{m} ) {T}_{x , t , max}^{-} \\ {T}_{x , t , m}^{+} = {u}_{x , t}^{m} {T}_{x , t , max}^{+} + ( 1 - {u}_{x , t}^{m} ) {T}_{x , t , f}^{+} \\ - {T}_{x , t , m}^{-} \leq {p}_{x , t}^{T} \leq {T}_{x , t , m}^{+} \\ {\sum }_{t = 1}^{T} {u}_{x , t}^{m} ( 1 - {u}_{x , t}^{m} ) \leq {γ}_{x}^{m}\end{matrix}$$

$$min {L}_{m} = {\sum }_{t = 1}^{T} \sqrt{{\sum }_{x = 1}^{{N}_{x}} {( {p}_{x , t}^{T} )}^{2}}$$

where

$${p}_{j , t}^{nt +}$$

is a load demand of a newly added j-th tie-line; Nₓ is the number of zones;

$${p}_{x , t}^{T}$$

is a peak shaving demand support power of the x-th zone at time t;

$${P}_{l , x}^{a , max}$$

is an upper power limit of the l-th tie-line in the x-th zone; Gₗ₋ₓ is a power transfer distribution factor between the x-th zone and the l-th tie-line; Gₗ₋ⱼ is a power transfer distribution factor between the l-th tie-line and the j-th tie-line;

$${p}_{t}^{l 0}$$

is a power flow of the l-th line at time t under the day-ahead dispatch plan;

$${P}_{j , t}^{nt , max}$$

is an upper power limit of the j-th tie-line at time t;

$${T}_{x , t , m}^{-}$$

is a minimum dispatch capability of the x-th zone at time t;

$${u}_{x , t}^{m}$$

is a binary state variable characterizing a dispatch capability mode of the x-th zone at time t;

$${T}_{x , t , m}^{+}$$

is a maximum dispatch capability of the x-th zone at time t;

$${γ}_{x}^{m}$$

is a set threshold for the number of mode switches of the x-th zone; and Lₘ is a target value characterizing balanced peak shaving.

According to a second aspect, the present disclosure provides a computer device, including a memory, a processor, and a computer program stored in the memory and executable on the processor, where the computer program is executed by the processor to implement the method for zonal joint peak shaving dispatch considering a day-ahead operation security domain described above.

According to a third aspect, the present disclosure provides a computer-readable storage medium, where the computer-readable storage medium stores a computer program, and the computer program, when executed by a processor, implements the method for zonal joint peak shaving dispatch considering a day-ahead operation security domain described above.

According to a fourth aspect, the present disclosure provides a computer program product, including a computer program, where the computer program, when executed by a processor, implements the method for zonal joint peak shaving dispatch considering a day-ahead operation security domain described above.

According to the specific embodiments provided by the present disclosure, the present disclosure achieves the following technical effects: The present disclosure provides a method for zonal joint peak shaving dispatch considering a day-ahead operation security domain, a device, a medium, and a product. A model dimensionality reduction strategy is used to reduce the dimensionality of decision variables and computational complexity. Through the ABSSA, rapid solution of optimization problems containing numerous binary variables is achieved, and the global search capability of the algorithm is improved using adaptive step size. The day-ahead operation security domain can describe the range of unit operating points and quantify the zonal dispatch capabilities of unit operating points. The double k-means clustering algorithm is used to screen the regulation capabilities, thereby obtaining the zonal dispatch capabilities, which facilitates the visualization of the internal regulation capability of the zone. The power transfer distribution factor provides an accurate description of transmission for peak shaving, and the APO algorithm is used to solve the peak shaving demand allocation model, ensuring balanced allocation of peak shaving demand, achieving rapid convergence of the allocation process, and improving allocation efficiency. A correction factor is introduced to correct the day-ahead dispatch plan, ensuring the feasibility of the corrected plan and reducing the implementation difficulty of the corrected day-ahead dispatch plan. The use of the EGO algorithm enables rapid finding of the optimal solution in complex dispatch correction problems, and improves the optimality of the corrected day-ahead dispatch plan. Further, the BiGRU-Attention neural network model is adopted to achieve rapid acquisition of the corrected zonal day-ahead dispatch plan.

### BRIEF DESCRIPTION OF THE DRAWINGS

To describe the technical solutions in the embodiments of the present disclosure or in the prior art more clearly, the drawings required for describing the embodiments are briefly described below. Apparently, the drawings in the following description show merely some embodiments of the present disclosure, and those of ordinary skill in the art may still derive other drawings from these drawings without creative efforts.

FIG. 1 is a schematic flowchart of a method for zonal joint peak shaving dispatch considering a day-ahead operation security domain according to an embodiment of the present disclosure;

FIG. 2 is a schematic architectural diagram of zonal joint peak shaving dispatch considering a day-ahead operation security domain;

FIG. 3 is an overview diagram of zonal joint peak shaving dispatch considering a day-ahead operation security domain; and

FIG. 4 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a method for zonal joint peak shaving dispatch considering a day-ahead operation security domain, a device, a medium, and a product, aiming to solve the problem that a day-ahead dispatch plan cannot be quickly corrected when facing new peak shaving demands.

To make the above objectives, features, and advantages of the present disclosure more obvious and easy to understand, the present disclosure will be further described in detail with reference to the accompanying drawings and specific implementations.

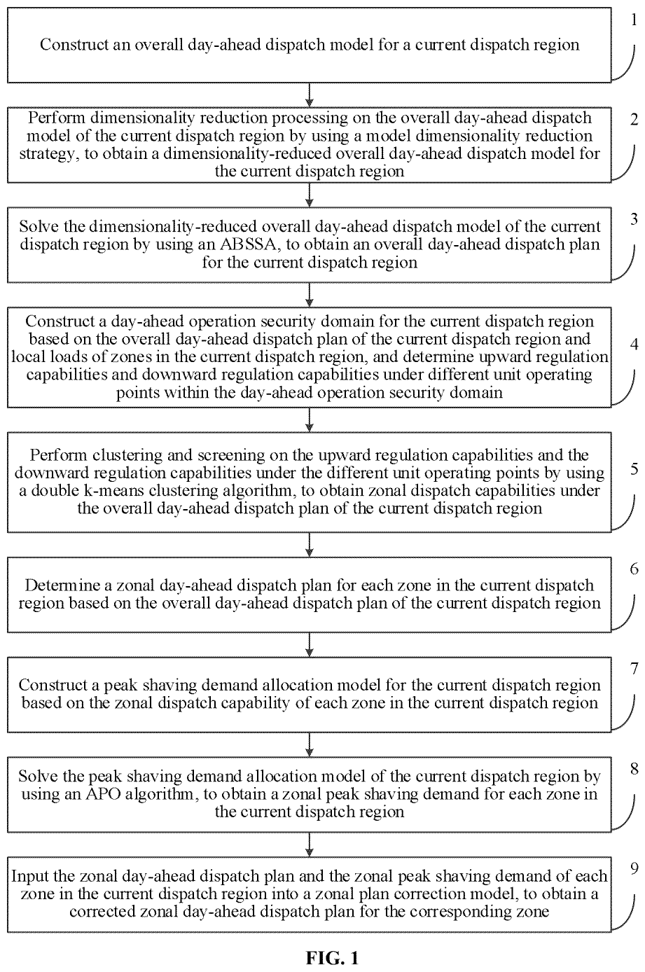

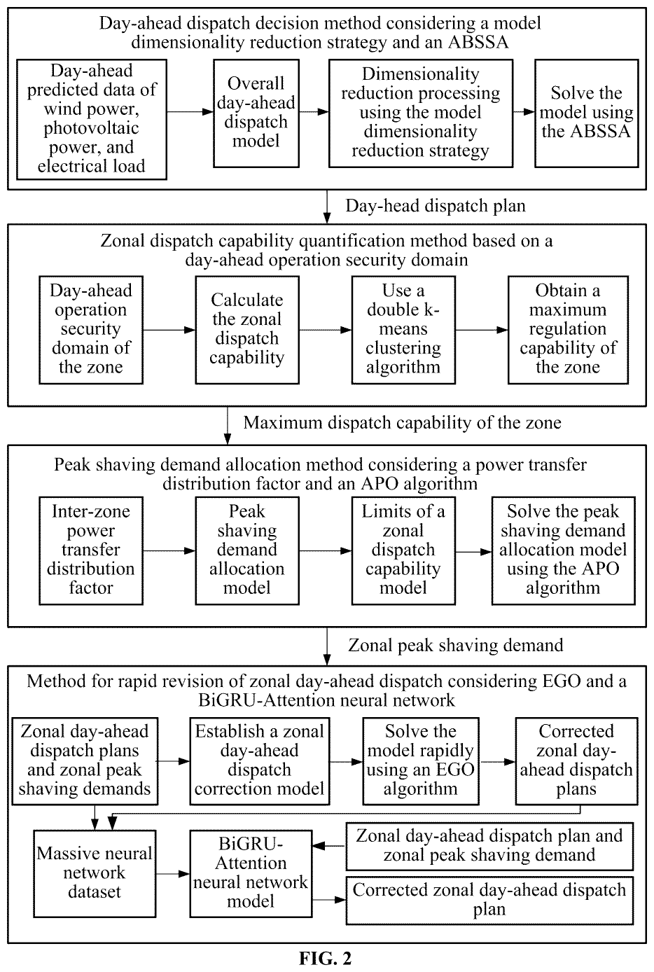

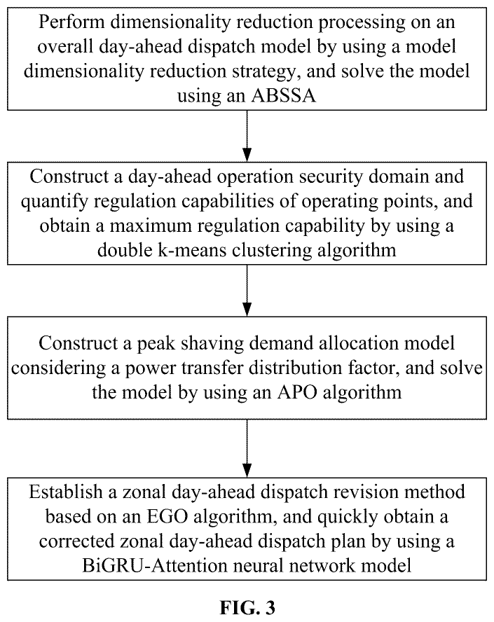

In an exemplary embodiment, as shown in FIG. 1 to FIG. 3, a method for zonal joint peak shaving dispatch considering a day-ahead operation security domain in this embodiment includes the following steps:
Step 1: Construct an overall day-ahead dispatch model for a current dispatch region.

The overall day-ahead dispatch model includes: an overall day-ahead dispatch objective function and overall constraints.

Specifically, based on day-ahead forecast data for wind power, photovoltaic power, and electrical load, a day-ahead dispatch plan for the output of thermal power units, wind power units, photovoltaic units, and electrochemical energy storage systems in wind-photovoltaic-thermal-energy storage systems is formulated. Furthermore, considering the demand response of the electrical load, the overall day-ahead dispatch model is established.

In an optional implementation, the overall day-ahead dispatch objective function includes:

$$\begin{matrix}{C}_{total}^{ahead} + {C}_{g} + {C}_{loss} + {C}_{es} + {C}_{dm} \\ \{ \begin{matrix}{C}_{g} = & {C}_{g , coal} + {C}_{g , on} + {C}_{g , r v} \\ = & {\sum }_{i = 1}^{{N}_{g}} {\sum }_{t = 1}^{T} {u}_{i , t}^{g} [ {a}_{i} {( {p}_{i , t}^{g} )}^{2} + {b}_{i} {p}_{i , t}^{g} + {c}_{i} ] + {\sum }_{i = 1}^{{N}_{g}} {\sum }_{t = 1}^{T} {c}_{i , t}^{g , o n} [ {u}_{i , t}^{g} ( 1 − {u}_{i , t}^{g} ) ] + \\ & {\sum }_{i = 1}^{{N}_{g}} {\sum }_{t = 1}^{T} [ {c}_{i , t}^{g , r v} ( {R}_{i , t}^{g +} + {R}_{i , t}^{g −} ) ] \\ {C}_{loss} = & {\sum }_{i = 1}^{{N}_{w}} {\sum }_{t = 1}^{T} [ {c}_{i , t}^{w} ( {p}_{i , t}^{w f} − {p}_{i , t}^{w} ) ] + {\sum }_{i = 1}^{{N}_{p}} {\sum }_{t = 1}^{T} [ {c}_{i , t}^{p} ( {p}_{i , t}^{p f} − {p}_{i , t}^{p} ) ] \\ {C}_{e s} = & {\sum }_{i = 1}^{{N}_{e s}} {\sum }_{t = 1}^{T} [ {c}_{i , t}^{e s} ( {p}_{i , t}^{e s , d} + {p}_{i , t}^{e s , c} ) ] \\ {C}_{dm} = & {\sum }_{i = 1}^{{N}_{l}} {\sum }_{t = 1}^{T} ( {c}_{i , t}^{d m} {p}_{i , t}^{d m} )\end{matrix}\end{matrix}$$

$${C}_{total}^{a h e a d}$$

is a total day-ahead dispatch cost; C_{g} is a thermal power cost; Cₗₒₛₛ is a curtailment cost; Cₑₛ is an energy storage operation cost; C_{dm} is a demand response cost; C_{g,coal} is a coal consumption cost; C_{g,on} is a start-stop cost; C_{g,rv} is a spinning reserve cost; N_{g} is the number of thermal power units in a dispatch region; T is a dispatch period;

$${u}_{i , t}^{g}$$

is a start-stop state variable of an i-th thermal power unit at time t; aᵢ, bᵢ, and cᵢ are coal consumption coefficients of thermal power;

$${P}_{i , t}^{g}$$

is actual output of the i-th thermal power unit at time t;

$${c}_{i , t}^{g , on}$$

is a single start-stop cost of the i-th thermal power unit at time t;

$${c}_{i , t}^{g , rv}$$

is a spinning reserve capacity cost coefficient of the i-th thermal power unit at time t;

$${R}_{i , t}^{g +}$$

is a positive spinning reserve capacity of the i-th thermal power unit at time t;

$${R}_{i , t}^{g -}$$

is a negative spinning reserve capacity of the i-th thermal power unit at time t; N_{w} is the number of wind power units in the dispatch region;

$${c}_{i , t}^{w}$$

is a curtailment cost coefficient of an i-th wind power unit at time t;

$${p}_{i , t}^{w f}$$

is predicted output of the i-th wind power unit at time t;

$${p}_{i , t}^{w}$$

is actual output of the i-th wind power unit at time t; Nₚ is the number of photovoltaic units in the dispatch region;

$${c}_{i , t}^{p}$$

is a curtailment cost coefficient of an i-th photovoltaic unit at time t;

$${p}_{i , t}^{pf}$$

is predicted output of the i-th photovoltaic unit at time t;

$${p}_{i , t}^{p}$$

is actual output of the i-th photovoltaic unit at time t; Nₑₛ is the number of electrochemical energy storage systems in the dispatch region;

$${c}_{i , t}^{e s}$$

is an operation cost per unit power of an i-th electrochemical energy storage system at time t;

$${p}_{i , t}^{es , d}$$

is a discharging power of the i-th electrochemical energy storage system at time t;

$${p}_{i , t}^{es , c}$$

is a charging power of the i-th electrochemical energy storage system at time t; Nₗ is the number of demand responses in the dispatch region;

$${c}_{i , t}^{dm}$$

is a cost coefficient of an i-th demand response at time t; and

$${p}_{i , t}^{dm}$$

is an i-th actual demand response at time t.

In an optional implementation, the overall constraints include: wind and photovoltaic safe operating range constraints, technical output upper and lower limits and ramp rate constraints of thermal power units, energy storage system operation constraints, power balance constraints, line power flow security constraints and tie-line constraints, system positive and negative spinning reserve constraints, and demand response model constraints.

The wind and photovoltaic safe operating range constraints include:

$$\{ \begin{matrix}{p}_{i , t}^{w , min} \leq {p}_{i , t}^{w} \leq {p}_{i , t}^{wf} \leq {p}_{i , t}^{w , max} \\ {p}_{i , t}^{p , min} \leq {p}_{i , t}^{p} \leq {p}_{i , t}^{pf} \leq {p}_{i , t}^{p , max}\end{matrix}$$

$${p}_{i , t}^{w , min}$$

is minimum output of the i-th wind power unit at time t;

$${p}_{i , t}^{w , max}$$

is maximum output of the i-th wind power unit at time t;

$${p}_{i , t}^{p , min}$$

is minimum output of the i-th photovoltaic unit at time t; and

$${p}_{i , t}^{p , max}$$

is maximum output of the i-th photovoltaic unit at time t.

The technical output upper and lower limits and ramp rate constraints of the thermal power units include:

$${u}_{i , t}^{g} {p}_{i , t}^{g , min} \leq {p}_{i , t}^{g} \leq {u}_{i , t}^{g} {p}_{i , t}^{g , max} . \\ \{ \begin{matrix}{p}_{i , t + 1}^{g} - {p}_{i , t}^{g} \leq {Q}_{i}^{g , up} {u}_{i , t}^{g} + {p}_{i , t + 1}^{g , min} ( {u}_{i , t + 1}^{g} - {u}_{i , t}^{g} ) + {p}_{i , t + 1}^{g , max} ( 1 - {u}_{i , t + 1}^{g} ) \\ {p}_{i , t}^{g} - {p}_{i , t + 1}^{g} \leq {Q}_{i}^{g , down} {u}_{i , t + 1}^{g} - {p}_{i , t + 1}^{g , min} ( {u}_{i , t + 1}^{g} - {u}_{i , t}^{g} ) + {p}_{i , t + 1}^{g , max} ( 1 - {u}_{i , t}^{g} )\end{matrix} .$$

$${p}_{i , t}^{g , min}$$

is minimum output of the i-th thermal ower unit at time t;

$${p}_{i , t}^{g , max}$$

is maximum output of the i-th thermal power unit at time t;

$${P}_{i , t + 1}^{g}$$

is actual output of the i-th thermal power unit at time t+1;

$${Q}_{i}^{g , up}$$

is a ramping-up power limit of the i-th thermal power unit;

$${p}_{i , t + 1}^{g , down}$$

is minimum output of the i-th thermal power unit at time t+1;

$${u}_{i , t + 1}^{g}$$

is a start-stop state variable of the i-th thermal power unit at time t+1;

$${p}_{i , t + 1}^{g , max}$$

is maximum output of the i-th thermal power unit at time t+1; and

$${Q}_{i}^{g , down}$$

is a ramping-down power limit of the i-th thermal power unit.

The energy storage system operation constraints include:

$$\{ \begin{matrix}{p}_{i , t}^{es , min} \leq {p}_{i , t}^{es , c} , {p}_{i , t}^{es , d} \leq {p}_{i , t}^{es , max} \\ {SoC}_{i , t + 1}^{e s} = {SoC}_{i , t}^{e s} + [ ( {η}_{i , t}^{es , c} {p}_{i , t}^{es , c} - {p}_{i , t}^{es , d} / {η}_{i , t}^{e s ,} ) Δ t ] / {E}_{i}^{e s} \\ {SoC}_{i , t}^{es , min} \leq {SoC}_{i , t}^{e s} \leq {SoC}_{i , t}^{es , max}\end{matrix} .$$

$${p}_{i , t}^{es , min}$$

is a lower ower limit of the i-th electrochemical energy storage system at time t;

$${p}_{i , t}^{es , max}$$

is an upper power limit of the i-th electrochemical energy storage system at time t;

$${SoC}_{i , t + 1}^{es}$$

is a state of charge of the i-th electrochemical energy storage system at time t+1;

$${SoC}_{i , t}^{es}$$

is a state of charge of the i-th electrochemical energy storage system at time t;

$${η}_{i , t}^{es , c}$$

is charging efficiency of the i-th electrochemical energy storage system at time t;

$${η}_{i , t}^{es , d}$$

is discharging efficiency of the i-th electrochemical energy storage system at time t; Δt is a t-th dispatch time period;

$${E}_{i}^{e s}$$

is rated energy of the i-th electrochemical energy storage system;

$${SoC}_{i , t}^{es , min}$$

is a low state of charge of the i-th electrochemical energy storage system at time t; and

$${SoC}_{i , t}^{es , max}$$

is a high state of charge of the i-th electrochemical energy storage system at time t;
The power balance constraints include:

$${\sum }_{i = 1}^{Ng} {p}_{i , t}^{g} + {\sum }_{i = 1}^{Nw} {p}_{i , t}^{w} + {\sum }_{i = 1}^{Np} {p}_{i , t}^{p} + {\sum }_{i = 1}^{Nes} ( {p}_{i , t}^{es , d} - {p}_{i , t}^{es , c} ) = {\sum }_{i = 1}^{{N}_{l}} ( {p}_{i , t}^{load} - {p}_{i , t}^{dm} ) + {\sum }_{j = 1}^{NT} {p}_{j , t}^{nt}$$

$${p}_{i , t}^{load}$$

is an i-th local load at time t;

$${p}_{j , t}^{nt}$$

is an outgoing load of a j-th tie-line at time t; and NT is the number of tie-lines with outgoing loads.

The line power flow security constraints and the tie-line constraints include:

$$- {P}_{l}^{max} \leq {p}_{l , t}^{k} \leq {P}_{l}^{max} .$$

$$- {P}_{j , t}^{nt , max} \leq {p}_{j , t}^{nt} \leq {P}_{j , t}^{nt , max} .$$

$${P}_{l}^{max}$$

upper power limit of an l-th line;

$${p}_{l , t}^{k}$$

is an actual power of the l-th line at time t;

$${P}_{j , t}^{nt , max}$$

is an upper power limit of the j-th tie-line; and

$${p}_{j , t}^{nt}$$

is an actual power of the j-th tie-line.

The system positive and negative spinning reserve constraints include:

$$\{ \begin{matrix}{\sum }_{i = 1}^{{N}_{g}} min \{ {p}_{i , t}^{g , max} - {p}_{i , t}^{g} , {Q}_{i}^{g , up} \} \geq {R}_{t}^{g +} \\ {\sum }_{i = 1}^{{N}_{g}} min \{ {p}_{i , t}^{g} - {p}_{i , t}^{g , min} , {Q}_{i}^{g , down} \} \geq {R}_{t}^{g -}\end{matrix}$$

$$\{ \begin{matrix}{R}_{t}^{g +} = {\sum }_{i = 1}^{{N}_{g}} {R}_{i , t}^{g +} \geq {\partial }^{l +} {\sum }_{i = 1}^{{N}_{l}} {p}_{i , t}^{load} + {\partial }^{w +} {\sum }_{i = 1}^{{N}_{w}} {p}_{i , t}^{w} + {\partial }^{p +} {\sum }_{i = 1}^{{N}_{p}} {p}_{i , t}^{p} \\ {R}_{t}^{g -} = {\sum }_{i = 1}^{{N}_{g}} {R}_{i , t}^{g -} \geq {\partial }^{l -} {\sum }_{i = 1}^{{N}_{l}} {p}_{i , t}^{load} + {\partial }^{w -} {\sum }_{i = 1}^{{N}_{w}} {p}_{i , t}^{w} + {\partial }^{p -} {\sum }_{i = 1}^{{N}_{p}} {p}_{i , t}^{p}\end{matrix}$$

$${R}_{t}^{g +}$$

is a total positive spinning reserve capacity at time t;

$${R}_{t}^{g -}$$

is a total negative spinning reserve capacity at time t; ∂^{w+} is an upward reserve coefficient for the wind power units; ∂^{p+} is an upward reserve coefficient for the photovoltaic units; ∂^{l+} is an upward reserve coefficient for the local loads; ∂^{w-} is a downward reserve coefficient for the wind power units; ∂^{p-} is a downward reserve coefficient for the photovoltaic units; and ∂^{l-} is a downward reserve coefficient for the local loads.

The demand response model constraints include:

$${p}_{i , min}^{dm} \leq {p}_{i , t}^{dm} \leq {k}_{i , max}^{dm} {p}_{i , max}^{load} .$$

$${p}_{i , min}^{dm}$$

is a lower limit value of the i-th demand response;

$${p}_{i , max}^{l o a d}$$

max is a day-ahead peak value of the i-th local load; and

$${k}_{i , max}^{dm}$$

is a maximum coefficient of the i-th demand response.
Step 2: Perform dimensionality reduction processing on the overall day-ahead dispatch model of the current dispatch region by using a model dimensionality reduction strategy, to obtain a dimensionality-reduced overall day-ahead dispatch model for the current dispatch region.

The model dimensionality reduction strategy includes a time period merging strategy and a constant-on-constant-off thermal power unit identification strategy.

Specifically, the time period merging strategy merges time periods of a calculation cycle based on the variation trend of the electrical load during different time periods within the calculation cycle. A net load change rate in the dispatch region is used as the basis for division:

$$\{ \begin{matrix}{p}_{t}^{e} = {\sum }_{i = 1}^{{N}_{l}} {p}_{i , t}^{load} + {\sum }_{j = 1}^{NT} {p}_{j , t}^{nt} - {\sum }_{i = 1}^{Nw} {p}_{i , t}^{wf} - {\sum }_{i = 1}^{Np} {p}_{i , t}^{pf} \\ Δ {p}_{t}^{e} = ( {p}_{t}^{e} - {p}_{t + 1}^{e} ) / {p}_{t}^{e}\end{matrix}$$

$${p}_{t}^{e}$$

is a net load at time t; and

$$Δ {p}_{t}^{e}$$

is a net load change rate at time t.

If the net load change rate is less than a set threshold, the time periods will be merged. To ensure consistent electrical energy after time period merging, equivalent calculation is performed on the net loads and the corresponding time periods:

$$\vert Δ {p}_{t}^{e} \vert \leq {ε}^{e}$$

$$\{ \begin{matrix}{p}_{t}^{{e}_{1}} = \frac{{p}_{t}^{e} Δ t + {p}_{t + 1}^{e} Δ ( t + 1 )}{Δ t + Δ ( t + 1 )} \\ Δ {t}_{1} = Δ t + Δ ( t + 1 )\end{matrix}$$

ε^{e} is a merging threshold;

$${p}_{t}^{{e}_{1}}$$

is an equivalent net load after merging at time t;

$${p}_{t + 1}^{e}$$

is a net load at time t+1; Δt₁ is an equivalent time period after merging; and Δ(t+1) is a (t+1)-th dispatch time period.

The constant-on-constant-off thermal power unit identification strategy classifies the thermal power units into constant-on units, constant-off units, and start-stop units based on preset unit operation information. In practice, thermal power units are often in a constant-on or constant-off state, with only some units requiring starting or stopping. Based on this characteristic, integer variables in the model that require branch calculation can be significantly reduced, thereby substantially reducing the state combination space of the system.
Step 3: Solve the dimensionality-reduced overall day-ahead dispatch model of the current dispatch region by using an ABSSA, to obtain an overall day-ahead dispatch plan for the current dispatch region.

Specifically, the Salp Swarm Algorithm (SSA) initializes a set of random positions for each population. An optimal position of all the populations is considered as a target, and other populations chase the target. Therefore, the position update is divided into two stages: a leader stage and a follower stage. During the optimization process, followers may not follow the leader and fall into a local optimal solution. A mutation operator is further introduced to enrich population diversity and enhance the search capability of the algorithm. For binary variables, an Arctan transfer function is used for exploration and exploitation of the binary search space.

$$\{ \begin{matrix}{M}_{a}^{0} = r a n d ( ( {M}_{a}^{max} + {M}_{a}^{min} ) / 2 , {M}_{a}^{max} + {M}_{a}^{min} - {M}_{a} ) \\ {L}_{o} = {L}_{o , max} - ( {L}_{o , max} - {L}_{o , min} / {it}_{max} ) \times it \\ {m}_{a , b} ( it + 1 ) = \{ \begin{matrix}1 , & Ac ( {m}_{a , b} ( it + 1 ) ) \geq r a n d ( 0 , 1 ) \\ 0 & otherwise\end{matrix}\end{matrix}$$

$${M}_{a}^{0}$$

is a random number distributed between two elements; rand is a random function;

$${M}_{a}^{max}$$

is a maximum element value in an a-th population;

$${M}_{a}^{min}$$

is a minimum element value in the a-th population; Mₐ is position information of the a-th population; Lₒ is an adaptive step size, which can prevent premature convergence, thereby producing smooth convergence; L_{o,max} and L_{o,min} are step size constant coefficients; itₘₐₓ is a maximum number of iterations; it is a current number of iterations; m_{a,b} is a decision variable for a binary variable of a b-th element in the a-th population; and Ac is an Arctan transfer function.

The specific solution process of the Adaptive Binary Salp Swarm Algorithm (ABSSA) is as follows: First, decision variables are initialized based on the boundaries of the overall day-ahead dispatch model to generate populations. Second, based on the leader stage and follower stage of SSA, positions of continuous decision variables are updated, and binary variables are updated using the Arctan transfer function. Then, a step size Lₒ is calculated, and quasi-opposite populations

$${M}_{a}^{0}$$

are also calculated; moreover, based on the change in target fitness for the a-th population, it is determined whether to update the position of the a-th population. Finally, the optimal position of the populations is updated, and the iteration count is incremented; the loop is terminated when the maximum number of iterations is reached.
Step 4: Construct a day-ahead operation security domain for the current dispatch region based on the overall day-ahead dispatch plan of the current dispatch region and local loads of zones in the current dispatch region, and determine upward regulation capabilities and downward regulation capabilities under different unit operating points within the day-ahead operation security domain.

Specifically, based on a start-stop plan of generator units within the zone and local loads of the zone, the day-ahead operation security domain is expressed as: considering the power supply structure characteristics and power demand distribution characteristics of the zone, a set of unit operating points that satisfy safe operation and power balance during the dispatch period under the unit start-stop states arranged in the overall day-ahead dispatch plan.

In an optional implementation, the day-ahead operation security domain includes:

$$Ω = \{ x \vert \begin{matrix}f ( x , y ) = 0 \\ g ( x , y , z ) \leq 0 \\ k ( x , y ) \leq 0\end{matrix} \} .$$

Ω is a set of all unit operating points in a zone; x is a key decision vector corresponding to all the unit operating points in the zone during the dispatch period; z is a discrete variable of a wind-photovoltaic-thermal-energy storage system in the zone; y is a vector formed by other system variables; f(x,y)=0 is a power flow equality constraint; g(x,y,z)≤0 is a unit commitment constraint set, including: the wind and photovoltaic safe operating range constraints, the technical output upper and lower limits and ramp rate constraints of the thermal power units, the energy storage system operation constraints, and the demand response model constraints; and k(x,y)≤0 is a security constraint set.

The power flow equality constraint is expressed as follows:

$${\sum }_{i = 1}^{Ng , x} {p}_{i , t}^{g} + {\sum }_{i = 1}^{Nw , x} {p}_{i , t}^{w} + {\sum }_{i = 1}^{Np , x} {p}_{i , t}^{p} + {\sum }_{i = 1}^{Nes , x} ( {p}_{i , t}^{es , d} - {p}_{i , t}^{es , c} ) = {\sum }_{i = 1}^{{N}_{l , x}} ( {p}_{i , t}^{load} - {p}_{i , t}^{dm} ) + {\sum }_{j = 1}^{{NT}_{x}} {p}_{j , t}^{nt}$$

N_{g,x} is the number of thermal power units in an x-th zone; N_{w,x} is the number of wind power units in the x-th zone; N_{p,x} is the number of photovoltaic units in the x-th zone; N_{es,x} is the number of electrochemical energy storage systems in the x-th zone; N_{l,x} is the number of local loads in the x-th zone; and NTₓ is the number of tie-lines in the x-th zone.

The security constraint set is expressed as follows:

$$\{ \begin{matrix}- {p}_{l , x}^{max} \leq {p}_{l , x , t}^{k} \leq {p}_{l , x}^{max} \\ - {p}_{x , j , t}^{nt , max} \leq {p}_{x , j , t}^{nt} \leq {p}_{x , j , t}^{nt , max} \\ {\sum }_{i = 1}^{{N}_{g , x}} min \{ {p}_{i , t}^{g , max} - {p}_{i , t}^{g} , {Q}_{i}^{g , up} \} \geq {R}_{t , x}^{g +} \\ {\sum }_{i = 1}^{{N}_{g , x}} min \{ {p}_{i , t}^{g} - {p}_{i , t}^{g , min} , {Q}_{i}^{g , down} \} \geq {R}_{t , x}^{g -} \\ {R}_{t , x}^{g +} \geq {\partial }^{l +} {\sum }_{i = 1}^{{N}_{l , x}} {p}_{i , t}^{load} + {\partial }^{w +} {\sum }_{i = 1}^{{N}_{w , x}} {p}_{i , t}^{w} + {\partial }^{p +} {\sum }_{i = 1}^{{N}_{p , x}} {p}_{i , t}^{p} \\ {R}_{t , x}^{g -} \geq {\partial }^{l -} {\sum }_{i = 1}^{{N}_{l , x}} {p}_{i , t}^{load} + {\partial }^{w -} {\sum }_{i = 1}^{{N}_{w , x}} {p}_{i , t}^{w} + {\partial }^{p -} {\sum }_{i = 1}^{{N}_{p , x}} {p}_{i , t}^{p}\end{matrix}$$

$${p}_{l , x , t}^{k}$$

is an actual power of an l-th line in the x-th zone at time t.

$${P}_{l , x}^{max}$$

is an upper power limit of the l-th line in the x-th zone.

$${p}_{x , j , t}^{nt}$$

is an actual power of a j-th tie-line in the x-th zone at time t.

$${P}_{x , j , t}^{nt , max}$$

is an upper power limit of the j-th tie-line in the x-th zone at time t.

$${R}_{t , x}^{g +}$$

is a positive spinning reserve capacity of the x-th zone at time t.

$${R}_{t , x}^{g -}$$

is a negative spinning reserve capacity of the x-th zone at time t.

In an optional implementation, a calculation formula for the upward regulation capability includes:

$${T}_{x , t}^{+} = {\sum }_{i = 1}^{{N}_{g , x}} [ min \{ {p}_{i , t}^{g , max} - {p}_{i , t}^{g} , {Q}_{i}^{g , up} \} - {R}_{i , t}^{g +} ] + {\sum }_{i = 1}^{{N}_{l , x}} [ {k}_{i , max}^{dm} {p}_{i , max}^{load} - {p}_{i , t}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es , max} - {SoC}_{i , t}^{es} ) {E}_{i}^{es} + ( {p}_{i , t}^{es , d} - {p}_{i , t}^{es , c} ) ] \}$$

A calculation formula for the downward regulation capability includes:

$${T}_{x , t}^{-} = {\sum }_{i = 1}^{{N}_{g , x}} [ min \{ {p}_{i , t}^{g , max} - {p}_{i , t}^{g , min} , {Q}_{i}^{g , down} \} - {R}_{i , t}^{g -} ] + {\sum }_{i = 1}^{{N}_{l , x}} [ {p}_{i , t}^{dm} - {p}_{i , min}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es} - {SoC}_{i , t}^{es , min} ) {E}_{i}^{es} + ( {p}_{i , t}^{es , d} - {p}_{i , t}^{es , c} ) ] \}$$

$${T}_{x , t}^{+}$$

is an upward regulation capability of the x-th zone at time t; and

$${T}_{x , t}^{-}$$

is a downward regulation capability of the x-th zone at time t.
Step 5: Perform clustering and screening on the upward regulation capabilities and the downward regulation capabilities under the different unit operating points by using a double k-means clustering algorithm, to obtain zonal dispatch capabilities under the overall day-ahead dispatch plan of the current dispatch region.

Specifically, under different unit operating points of the day-ahead operation security domain, the regulation capability is inconsistent. To screen out a maximum upward regulation capability and a maximum downward regulation capability, a double k-means clustering algorithm is used for clustering and screening, including the following steps.

In the first step, a large number of unit operating points in the day-ahead operation security domain are generated using a Monte Carlo sampling method, and the upward regulation capabilities and the downward regulation capabilities are calculated according to the calculation formulas for upward regulation capability and downward regulation capability respectively. The regulation capability of the k-th unit operating point is

$$\{ {T}_{x , t , k}^{+} , {T}_{x , t , k}^{-} \vert ∀ t \} .$$

In the second step, taking the upward regulation capabilities and the downward regulation capabilities across all time periods as a clustering point set, clustering is performed using a k-means clustering algorithm, to generate sub-clusters. Further, taking the upward regulation capabilities and the downward regulation capabilities across all time periods within each sub-cluster as clustering point sets respectively, clustering is performed to generate upward regulation capability sub-sub-clusters and downward regulation capability sub-sub-clusters.

In the third step, averages of the clustering point sets in each sub-sub-cluster are calculated and summed to obtain a sub-sub-cluster target value. Further, a largest upward regulation capability sub-sub-cluster target value and a largest downward regulation capability sub-sub-cluster target value within the sub-cluster are screened out to represent the sub-cluster.

In the fourth step, the representative values of all the sub-clusters are compared. Since the maximum upward regulation capability and the maximum downward regulation capability cannot be achieved simultaneously, a representative sub-cluster with the maximum upward regulation capability and its corresponding downward regulation capability, and a representative sub-cluster with the maximum downward regulation capability and its corresponding upward regulation capability are selected, obtaining two schemes:

$$\{ \begin{matrix}{T}_{x , t , f}^{-} = {k}_{x , t}^{+} {T}_{x , t , max}^{+} \\ {T}_{x , t , f}^{+} = {k}_{x , t}^{-} {T}_{x , t , max}^{-}\end{matrix} .$$

$${T}_{x , t , max}^{+}$$

is a maximum upward regulation capability of the x-th zone at time t;

$${T}_{x , t , f}^{-}$$

is a downward regulation capability corresponding to the maximum upward regulation capability of the x-th zone at time t;

$${T}_{x , t , max}^{-}$$

is a maximum downward regulation capability of the x-th zone at time t;

$${T}_{x , t , f}^{+}$$

is an upward regulation capability corresponding to the maximum downward regulation capability of the x-th zone at time t;

$${k}_{x , t}^{+} and {k}_{x , t}^{-}$$

are matching coefficients of the x-th zone at time t.
Step 6: Determine a zonal day-ahead dispatch plan for each zone in the current dispatch region based on the overall day-ahead dispatch plan of the current dispatch region.
Step 7: Construct a peak shaving demand allocation model for the current dispatch region based on the zonal dispatch capability of each zone in the current dispatch region.

Specifically, according to the zone structure, the zones are considered as generalized nodes, focusing only on the input-output characteristics. Power lines originally connecting the zones within the region are regarded as newly added inter-zone tie-lines. A power transfer distribution factors are established using inter-zone tie-lines, reflecting the impact of the input and output of the generalized zone nodes on the power flow of the inter-zone tie-lines:

$${G}_{k - i} = \frac{{x}_{mi} - {x}_{ni}}{{x}_{k}} .$$

Gₖ₋ᵢ is a power transfer distribution factor between an i-th node and a k-th tie-line branch; xₘᵢ is a reactance value between an m-th node and the i-th node; xₙᵢ is a reactance value between an n-th node and the i-th node; xₘᵢ and xₙᵢ are parameters in a grid branch reactance matrix; xₖ is a reactance value of the k-th tie-line branch.

In an optional implementation, the peak shaving demand originates from the outgoing load of tie-lines. Considering the regulation capabilities of the zones, the suddenly increased peak shaving demand of the tie-line will be allocated to each zone within the dispatch region. The peak shaving demand allocation model includes: peak shaving demand constraints, linearization constraints, and a balanced peak shaving objective function.
(1) The allocation of peak shaving demand should satisfy peak shaving demand constraints such as power balance constraints, tie-line power flow security constraints, external tie-line constraints, and regulation capability constraints. The specific peak shaving demand constraints include:

$$\{ \begin{matrix}{\sum }_{j = 1}^{NT} {p}_{j , t}^{nt +} = {\sum }_{x = 1}^{{N}_{x}} {p}_{x , t}^{T} \\ - {P}_{l , x}^{a , max} \leq {\sum }_{x = 1}^{{N}_{x}} {G}_{l - x} {p}_{x , t}^{T} - {\sum }_{j = 1}^{NT} {G}_{l - j} {p}_{j , t}^{nt +} + {p}_{t}^{10} \leq {P}_{l , x}^{a , max} \\ - {P}_{j , t}^{nt , max} \leq {p}_{j , t}^{nt} + {p}_{j , t}^{nt +} \leq {P}_{j , t}^{nt , max} \\ - {T}_{x , t , f}^{-} \leq {p}_{x , t}^{T} \leq {T}_{x , t , max}^{+} or - {T}_{x , t , max}^{-} \leq {p}_{x , t}^{T} \leq {T}_{x , t , f}^{+}\end{matrix}$$

(2) The regulation capability constraints are linearized using binary variables. Meanwhile, the number of regulation capability mode switches should be less than a set threshold. The linearization constraints are:

$$\{ \begin{matrix}{T}_{x , t , m}^{-} = {u}_{x , t}^{m} {T}_{x , t , f}^{-} + ( 1 - {u}_{x , t}^{m} ) {T}_{x , t , max}^{-} \\ {T}_{x , t , m}^{+} = {u}_{x , t}^{m} {T}_{x , t , max}^{+} + ( 1 - {u}_{x , t}^{m} ) {T}_{x , t , f}^{+} \\ - {T}_{x , t , m}^{-} \leq {p}_{x , t}^{T} \leq {T}_{x , t , m}^{+} \\ {\sum }_{t = 1}^{T} {u}_{x , t}^{m} ( 1 - {u}_{x , t}^{m} ) \leq {γ}_{x}^{m}\end{matrix}$$

(3) To balance the regulation capability of each zone and enable each zone to participate in the peak shaving process evenly, the following balanced peak shaving objective function is established:

$$min {L}_{m} = {\sum }_{t = 1}^{T} \sqrt{{\sum }_{x = 1}^{{N}_{x}} {( {p}_{x , t}^{T} )}^{2}}$$

$${p}_{j , t}^{n t +}$$

is a load demand of a newly added j-th tie-line; Nₓ is the number of zones;

$${p}_{x , t}^{T}$$

is a peak shaving demand support power of the x-th zone at time t;

$${P}_{l , x}^{a , max}$$

is an upper power limit of the l-th tie-line in the x-th zone; Gₗ₋ₓ is a power transfer distribution factor between the x-th zone and the l-th tie-line; Gₗ₋ⱼ is a power transfer distribution factor between the l-th tie-line and the j-th tie-line;

$${p}_{t}^{l 0}$$

is a power flow of the l-th line at time t under the day-ahead dispatch plan;

$${P}_{j , t}^{n t , max}$$

is an upper power limit of the j-th tie-line at time t;

$${T}_{x , t , m}^{-}$$

is a minimum regulation capability of the x-th zone at time t;

$${u}_{x , t}^{m}$$

is a binary state variable characterizing a regulation capability mode of the x-th zone at time t;

$${T}_{x , t , m}^{+}$$

is a maximum regulation capability of the x-th zone at time t;

$${γ}_{x}^{m}$$

is a set threshold for the number of mode switches of the x-th zone; and Lₘ is a target value characterizing balanced peak shaving.
Step 8: Solve the peak shaving demand allocation model of the current dispatch region by using an APO algorithm, to obtain a zonal peak shaving demand for each zone in the current dispatch region.

Specifically, the Arctic Puffin Optimization (APO) algorithm consists of an aerial flight (exploration) stage and an underwater foraging (exploitation) stage. In the exploration stage, the introduction of flight and velocity factor mechanisms enhances the ability of the algorithm to escape local optima and improves convergence speed. In the exploitation stage, strategies such as cooperation and adaptive change factors are adopted to ensure that the algorithm can effectively utilize the current optimal solution and guide the search direction. The exploration stage includes an aerial search strategy and a diving predation strategy. The exploitation stage is divided into a collective foraging strategy, an intensified search strategy, and a predator avoidance strategy. The specific iterative equations are as follows:

$$\{ \begin{matrix}{J}_{h}^{q + 1} = {H}_{h}^{q} + ( {H}_{h}^{q} - {H}_{v}^{q} ) \cdot L ( d ) + {V}_{a} \\ {K}_{h}^{q + 1} = {J}_{h}^{q + 1} \cdot {S}_{a}\end{matrix} .$$

$$\{ \begin{matrix}{W}_{h}^{q + 1} = \{ \begin{matrix}{H}_{v 1}^{q} + {U}_{a} \cdot ( {H}_{v 2}^{q} - {H}_{v 3}^{q} ) \cdot L ( d ) , rand \geq 0.5 \\ {H}_{v 1}^{q} + {U}_{a} \cdot ( {H}_{v 2}^{1} - {H}_{v 3}^{q} ) , rand < 0.5\end{matrix} \\ {J}_{h}^{q + 1} = {W}_{h}^{q + 1} \cdot ( 1 + {f}_{a} ) \\ {K}_{h}^{q + 1} = \{ \begin{matrix}{H}_{h}^{q} + {U}_{a} \cdot ( {H}_{v 1}^{q} - {H}_{v 2}^{q} ) \cdot L ( d ) , rand \geq 0.5 \\ {H}_{h}^{q} + {α}_{a} \cdot ( {H}_{v 1}^{q} - {H}_{v 2}^{q} ) , rand < 0.5\end{matrix}\end{matrix} .$$

$${J}_{h}^{q + 1}$$

is a candidate solution updated by the first-stage strategy;

$${H}_{h}^{q}$$

is a current h-th candidate solution in the population;

$${H}_{v}^{q}$$

is another candidate solution randomly selected different from

$${H}_{h}^{q} ;$$

L(d) is a random number generated during flight; Vₐ is a random parameter concerning the standard normal distribution;

$${K}_{h}^{q + 1}$$

is a candidate solution updated by the second-stage strategy; Sₐ is a velocity coefficient;

$${W}_{h}^{q + 1}$$

is a candidate solution updated by the collective foraging strategy;

$${H}_{v 1}^{q} , {H}_{v 2}^{q} , and {H}_{v 3}^{q}$$

are mutually distinct candidate solutions randomly selected; Uₐ is a cooperation factor; fₐ is an adaptive factor; and αₐ is a random number uniformly distributed between 0 and 1.

The specific implementation process of the APO algorithm is as follows: First, the population is initialized based on the boundaries of zone decision variables. Second, based on the conversion factor related to the number of iterations, it is determined whether to enter the aerial flight stage or the underwater foraging stage. Furthermore, in the aerial flight stage, the aerial search strategy and the diving predation strategy are sequentially executed, while in the underwater foraging stage, the collective foraging strategy, the intensified search strategy, and the predator avoidance strategy are sequentially executed. The top Nₐ individuals with the best fitness values from all strategies within the stage are selected to form a new population. Finally, iteration is performed continuously until the maximum number of iterations is reached.
Step 9: Input the zonal day-ahead dispatch plan and the zonal peak shaving demand of each zone in the current dispatch region into a zonal plan correction model, to obtain a corrected zonal day-ahead dispatch plan for the corresponding zone.

The zonal plan correction model is obtained by training a BiGRU-Attention neural network.

In an optional implementation, a process of determining the zonal plan correction model includes:
Step 91: Generate zonal day-ahead dispatch plans and zonal peak shaving demands for each zone of a plurality of training regions by using a random function.
Step 92: Construct a zonal day-ahead dispatch correction model for each training dispatch region based on an overall day-ahead dispatch plan of each training dispatch region and the zonal peak shaving demand of each zone.

Specifically, based on the overall day-ahead dispatch plan, to meet the assigned zonal peak shaving demand, the output plan of generator units within the zone needs to be readjusted. The marginal cost of the generator unit under the overall day-ahead dispatch plan is regarded as a correction factor. A lower marginal cost of the generator unit corresponds to a smaller correction factor. By presetting correction factors for the generator units, rapid correction of the zonal day-ahead dispatch plan is achieved. The zonal day-ahead dispatch correction model includes: a deviation objective function and internal constraints.
(1) Considering the thermal power units, demand responses, and electrochemical energy storage systems that provide regulation capabilities, with an objective of minimizing the deviation of the overall day-ahead dispatch plan, the deviation objective function is constructed:

$${Q}_{x} = {\sum }_{i = 1}^{{N}_{g , x}} {\sum }_{t = 1}^{T} {λ}_{i , t}^{g} [ {( {p}_{i , t}^{g} - {p}_{i , t}^{g 0} )}^{2} ] + {\sum }_{i = 1}^{{N}_{l , x}} {\sum }_{t = 1}^{T} {λ}_{i , t}^{d m} [ {( {p}_{i , t}^{d m} - {p}_{i , t}^{d m 0} )}^{2} ] + {\sum }_{i = 1}^{{N}_{ex , x}} {\sum }_{t = 1}^{T} {λ}_{i , t}^{e x} [ {( {p}_{i , t}^{es , d} - {p}_{i , t}^{es , c} - {p}_{i , t}^{es , d 0} + {p}_{i , t}^{es , c 0} )}^{2} ]$$

Qₓ is the deviation;

$${λ}_{i , t}^{g}$$

is a correction factor of the i-th thermal power unit at time t;

$${p}_{i , t}^{g 0}$$

is output of the i-th thermal power unit under the day-ahead dispatch plan; N_{l,x} is the number of local loads in the x-th zone;

$${λ}_{i , t}^{d m}$$

is a correction factor of the i-th demand response at time t;

$${p}_{i , t}^{d m 0}$$

is the i-th demand response at time t under the day-ahead dispatch plan;

$${λ}_{i , t}^{ex}$$

is a correction factor of the i-th electrochemical energy storage system at time t;

$${p}_{i , t}^{e s , d 0}$$

is a discharging power of the i-th electrochemical energy storage system at time t under the day-ahead dispatch plan;

$${p}_{i , t}^{es , c 0}$$

is a charging power of the i-th electrochemical energy storage system at time t under the day-ahead dispatch plan.
(2) The internal constraints should be satisfied within the zone. The internal constraints include: the following formula, as well as the technical output upper and lower limits and ramp rate constraints of the thermal power units, the energy storage system operation constraints, and the demand response model constraints.

$$\{ \begin{matrix}\begin{matrix}{\sum }_{i = 1}^{N g , x} {p}_{i , t}^{g} + {\sum }_{i = 1}^{Nw , x} {p}_{i , t}^{w 0} + {\sum }_{i = 1}^{N p , x} {p}_{i , t}^{p 0} + {\sum }_{i = 1}^{N es , x} ( {p}_{i , t}^{e s , d} - {p}_{i , t}^{es , c} ) = \\ {\sum }_{i = 1}^{{N}_{l , x}} ( {p}_{i , t}^{l o a d} - {p}_{i , t}^{d m} ) + {\sum }_{j = 1}^{N {T}_{x}} ( {p}_{j , t}^{n t} + {p}_{j , t}^{n t +} )\end{matrix} \\ \begin{matrix}- {P}_{l , x}^{max} \leq {\sum }_{i ∈ \{ {N}_{g , x} , {N}_{w , x} , {N}_{p , x} , {N}_{es , x} \}} {G}_{x , l - i} {p}_{i , t} - \\ {\sum }_{j = 1}^{N {T}_{x}} {G}_{x , l - j} ( {p}_{j , t}^{n t} + {p}_{j , t}^{n t +} ) - {\sum }_{p = 1}^{{N}_{l , x}} {G}_{x , l - p} ( {p}_{p , t}^{l o a d} - {p}_{p , t}^{d m} ) \leq {P}_{l , x}^{max}\end{matrix}\end{matrix}$$

$${p}_{i , t}^{w 0}$$

is output of the i-th wind power unit at time t under the day-ahead dispatch plan;

$${p}_{i , t}^{p 0}$$

is output of the i-th photovoltaic unit at time t under the day-ahead dispatch plan;

$${p}_{j , t}^{n t +}$$

is an increment of the outgoing load of the j-th tie-line at time t; G_{x,l-i} is a power transfer distribution factor between the l-th line and the i-th node within the x-th zone; p_{i,t} is a power injection of the i-th node at time t under the day-ahead dispatch plan; G_{x,l-j} is a power transfer distribution factor between the l-th line and the j-th node within the x-th zone; and G_{x,l-p} is a power transfer distribution factor between the l-th line and a p-th node within the x-th zone.
Step 93: Solve the zonal day-ahead dispatch correction model of each training dispatch region by using an EGO algorithm, to obtain a corrected zonal day-ahead dispatch plan for each training dispatch region.

Specifically, for large-scale optimization problems, the Eel and Grouper Optimizer (EGO) algorithm has a strong capability to balance exploitation and exploration abilities. The EGO algorithm utilizes the symbiotic foraging relationship between eels and groupers in the marine ecosystem, dividing the optimization process into three stages: grouper tracking prey (tracking stage), grouper signaling to the moray eel (signaling stage), and cooperative hunting (hunting stage). The specific mathematical models are as follows:

$$\{ \begin{matrix}{W}_{s}^{u + 1} = {W}_{rand}^{u} + {O}_{e 1} \cdot \vert {W}_{s}^{u} - {O}_{e 2} \cdot {W}_{rand}^{u} \vert \\ W {b}_{s}^{u + 1} = {W}_{s}^{u + 1} , {f}_{e} ( {W}_{s}^{u + 1} ) > {f}_{e} ( W {b}_{s}^{u} )\end{matrix} .$$

$${We}_{s}^{u} = {O}_{e 2} W {b}_{s}^{u} , {r}_{e 1} \leq ( {t}_{e} / {it}_{e}^{max} ) .$$

$$\{ \begin{matrix}{W}_{s}^{u + 1} = ( 0.8 {W}_{e 1} + 0.2 {W}_{e 2} ) / 2 , rand 1 < 0.5 \\ {W}_{s}^{u + 1} = ( 0.2 {W}_{e 1} + 0.8 {W}_{e 2} ) / 2 , rand 1 \geq 0.5\end{matrix} .$$

$${W}_{s}^{u + 1}$$

is position information of an s-th individual at a (u+1)-th iteration;

$${W}_{r a n d}^{u}$$

is a random position of the s-th individual at a u-th iteration; Oₑ₁ and Oₑ₂ are random coefficients;

$${W}_{s}^{u}$$

is position information of the s-th individual at the u-th iteration; fₑ(·) is a fitness function for calculating a position target value;

$$W {b}_{s}^{u + 1}$$

is an optimal position of the s-th individual at the (u+1)-th iteration;

$$W {b}_{s}^{u}$$

is an optimal position of the s-th individual at the u-th iteration;

$$W {e}_{s}^{u}$$

is position information of an s-th affiliated individual at the u-th iteration; rₑ₁ is a random number between 0 and 1; tₑ is a current number of iterations;

$$i {t}_{e}^{max}$$

is a maximum number of iterations; Wₑ₁ and Wₑ₂ are positional distances between affiliated individuals and an individual; and rand1 is a random number between 0 and 1.

The specific implementation process of the EGO algorithm is as follows: First, the population is initialized for decision variables. Second, the tracking stage is performed, updating the optimal position based on the position target value. Third, the signaling stage is performed, updating the position information of the affiliated individuals. Fourth, based on a random function, individual position update information is updated for the next iteration using the positional distances between the affiliated individuals and the individual. Finally, iteration is performed continuously until the maximum number of iterations is reached.
Step 94: Construct the BiGRU-Attention neural network based on a forward gated recurrent unit, a backward gated recurrent unit, and an attention mechanism.
Step 95: Train the BiGRU-Attention neural network by using the zonal day-ahead dispatch plan and the zonal peak shaving demand of each zone of each training dispatch region as input, and the corrected zonal day-ahead dispatch plan of the corresponding zone as output, to obtain the zonal plan correction model.

Specifically, when the day-ahead dispatch plan and the zonal peak shaving demand are known, by using the zonal plan correction model constructed based on the BiGRU-Attention neural network, the corrected zonal day-ahead dispatch plan can be obtained quickly. The specific process is as follows: First, a large number of zonal day-ahead dispatch plans and zonal peak shaving demands, and the EGO algorithm is used for solution to obtain corresponding corrected zonal day-ahead dispatch plans. Further, using the massive data of zonal day-ahead dispatch plans, zonal peak shaving demands, and corrected zonal day-ahead dispatch plans as base data, a massive neural network dataset is constructed. Second, a BiGRU-Attention neural network is constructed. BiGRU is a network model including a forward gated recurrent unit and a backward gated recurrent unit, enabling deep feature extraction through forward and backward computation of time series. The attention mechanism, by assigning different weights to input features, can prevent features containing important information from vanishing as the step size increases. Third, the BiGRU-Attention neural network is trained using the massive neural network dataset composed of the zonal day-ahead dispatch plans, zonal peak shaving demands, and corrected zonal day-ahead dispatch plans of each zone in each training dispatch region. After the training is completed, the zonal plan correction model is obtained.

In an exemplary embodiment, a computer device is provided, including a memory, a processor, and a computer program stored in the memory and executable on the processor. The processor executes the computer program to implement the method for zonal joint peak shaving dispatch considering a day-ahead operation security domain.

In an exemplary embodiment, a computer-readable storage medium is provided. The computer-readable storage medium stores a computer program, and the computer program, executed by a processor, implement the steps of the method for zonal joint peak shaving dispatch considering a day-ahead operation security domain.

In an exemplary embodiment, a computer program product is provided, including a computer program. The computer program, when executed by a processor, implements the method for zonal joint peak shaving dispatch considering a day-ahead operation security domain.

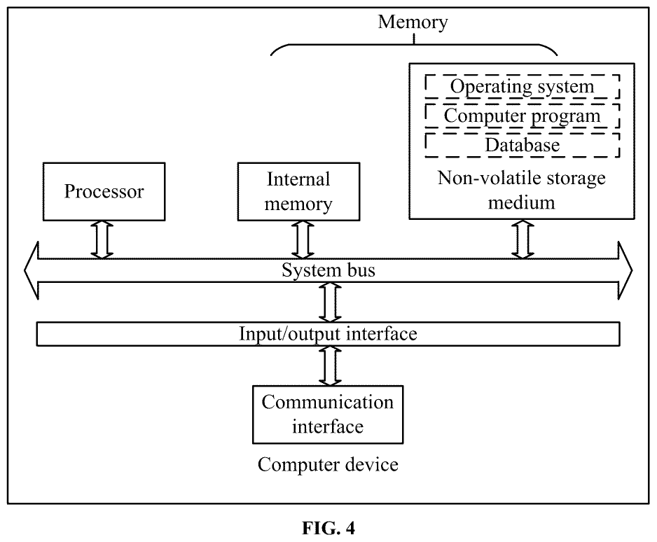

In an exemplary embodiment, a computer device is provided. The computer device may be a server or a terminal, and an internal structure thereof may be as shown in FIG. 4. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer apparatus includes a nonvolatile storage medium, and an internal memory. The non-volatile storage medium stores an operating system, a computer program, and a database. The internal memory provides an environment for operations of the operating system and the computer program in the non-volatile storage medium. The input/output interface of the computer apparatus is configured to exchange information between the processor and an external apparatus. The communication interface of the computer apparatus is configured to communicate with an external terminal through a network. The computer program, when executed by a processor, implements the method for zonal joint peak shaving dispatch considering a day-ahead operation security domain described above.

Those skilled in the art may understand that the structure shown in FIG. 4 is only a block diagram of a part of the structure related to the solutions of the present disclosure and does not constitute a limitation on a computer device to which the solutions of the present disclosure are applied. Specifically, the computer device may include more or less components than those shown in the figure, or combine some components, or have different component arrangements.

It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A method for zonal joint peak shaving dispatch considering a day-ahead operation security domain, comprising:
constructing an overall day-ahead dispatch model for a current dispatch region, wherein the overall day-ahead dispatch model comprises: an overall day-ahead dispatch objective function and overall constraints;
performing dimensionality reduction processing on the overall day-ahead dispatch model of the current dispatch region by using a model dimensionality reduction strategy, to obtain a dimensionality-reduced overall day-ahead dispatch model for the current dispatch region, wherein the model dimensionality reduction strategy comprises: a time period merging strategy and a constant-on-constant-off thermal power unit identification strategy;
solving the dimensionality-reduced overall day-ahead dispatch model of the current dispatch region by using an Adaptive Binary Salp Swarm Algorithm (ABSSA), to obtain an overall day-ahead dispatch plan for the current dispatch region;
constructing a day-ahead operation security domain for the current dispatch region based on the overall day-ahead dispatch plan of the current dispatch region and local loads of zones in the current dispatch region, and determining upward regulation capabilities and downward regulation capabilities under different unit operating points within the day-ahead operation security domain;
performing clustering and screening on the upward regulation capabilities and the downward regulation capabilities under the different unit operating points by using a double k-means clustering algorithm, to obtain zonal dispatch capabilities under the overall day-ahead dispatch plan of the current dispatch region;
determining a zonal day-ahead dispatch plan for each zone in the current dispatch region based on the overall day-ahead dispatch plan of the current dispatch region;
constructing a peak shaving demand allocation model for the current dispatch region based on the zonal dispatch capability of each zone in the current dispatch region;
solving the peak shaving demand allocation model of the current dispatch region by using an Arctic Puffin Optimization (APO) algorithm, to obtain a zonal peak shaving demand for each zone in the current dispatch region; and
inputting the zonal day-ahead dispatch plan and the zonal peak shaving demand of each zone in the current dispatch region into a zonal plan correction model, to obtain a corrected zonal day-ahead dispatch plan for a corresponding zone, wherein the zonal plan correction model is obtained by training a Bidirectional Gated Recurrent Unit (BiGRU)-Attention neural network.

2. The method for zonal joint peak shaving dispatch considering a day-ahead operation security domain according to claim 1, wherein a process of determining the zonal plan correction model comprises:
generating zonal day-ahead dispatch plans and zonal peak shaving demands for each zone of a plurality of training regions by using a random function;
constructing a zonal day-ahead dispatch correction model for each training dispatch region based on an overall day-ahead dispatch plan of each training dispatch region and the zonal peak shaving demand of each zone;
solving the zonal day-ahead dispatch correction model of each training dispatch region by using an Eel and Grouper Optimizer (EGO) algorithm, to obtain a corrected zonal day-ahead dispatch plan for each training dispatch region;
constructing the BiGRU-Attention neural network based on a forward gated recurrent unit, a backward gated recurrent unit, and an attention mechanism; and
training the BiGRU-Attention neural network by using the zonal day-ahead dispatch plan and the zonal peak shaving demand of each zone of each training dispatch region as input, and the corrected zonal day-ahead dispatch plan of the corresponding zone as output, to obtain the zonal plan correction model.

3. The method for zonal joint peak shaving dispatch considering a day-ahead operation security domain according to claim 1, wherein the overall day-ahead dispatch objective function comprises:
$${C}_{total}^{a h e a d} = {C}_{g} + {C}_{l o s s} + {C}_{e s} + {C}_{d m} ;$$
$$\{ \begin{matrix}\begin{matrix}{C}_{g} = {C}_{g , c o a l} + {C}_{g , on} + {C}_{g , rv} = {\sum }_{i = 1}^{{N}_{g}} {\sum }_{t = 1}^{T} {u}_{i , t}^{g} [ {{a}_{i} ( {p}_{i , t}^{g} )}^{2} + {b}_{i} {p}_{i , t}^{g} + {c}_{i} ] + \\ {\sum }_{i = 1}^{{N}_{g}} {\sum }_{t = 1}^{T} {c}_{i , t}^{g , on} [ {u}_{i , t}^{g} ( 1 - {u}_{i , t}^{g} ) ] + {\sum }_{i = 1}^{{N}_{g}} {\sum }_{t = 1}^{T} [ {c}_{i , t}^{g , rv} ( {R}_{i , t}^{g +} + {R}_{i , t}^{g -} ) ]\end{matrix} \\ {C}_{l o s s} = {\sum }_{i = 1}^{{N}_{w}} {\sum }_{r = 1}^{T} [ {c}_{i , t}^{w} ( {p}_{i , t}^{w f} - {p}_{i , t}^{w} ) ] + {\sum }_{i = 1}^{{N}_{p}} {\sum }_{t = 1}^{T} [ {c}_{i , t}^{p} ( {p}_{i , t}^{p f} - {p}_{i , t}^{p} ) ] \\ {C}_{e s} = {\sum }_{i = 1}^{{N}_{e s}} {\sum }_{t = 1}^{T} [ {c}_{i , t}^{e s} ( {p}_{i , t}^{es , d} + {p}_{i , t}^{es , c} ) ] \\ {C}_{d m} = {\sum }_{i = 1}^{{N}_{l}} {\sum }_{t = 1}^{T} ( {c}_{i , t}^{d m} {p}_{i , t}^{d m} )\end{matrix}$$
wherein
$${C}_{total}^{a h e a d}$$
is a total day-ahead dispatch cost; C_{g} is a thermal power cost; Cₗₒₛₛ is a curtailment cost; Cₑₛ is an energy storage operation cost; C_{dm} is a demand response cost; C_{g,coal} is a coal consumption cost; C_{q,on} is a start-stop cost; C_{q,rv} is a spinning reserve cost; N_{g} is a number of thermal power units in a dispatch region; T is a dispatch period;
$${u}_{i , t}^{g}$$
is a start-stop state variable of an i-th thermal power unit at time t; aᵢ, bᵢ, and cᵢ are coal consumption coefficients of thermal power;
$${P}_{i , t}^{g}$$
is actual output of the i-th thermal power unit at time t;
$${c}_{i , t}^{g , on}$$
is a single start-stop cost of the i-th thermal power unit at time t;
$${c}_{i , t}^{g , rv}$$
is a spinning reserve capacity cost coefficient of the i-th thermal power unit at time t;
$${R}_{i , t}^{g +}$$
is a positive spinning reserve capacity of the i-th thermal power unit at time t;
$${R}_{i , t}^{g -}$$
is a negative spinning reserve capacity of the i-th thermal power unit at time t; N_{w} is a number of wind power units in the dispatch region;
$${c}_{i , t}^{w}$$
is a curtailment cost coefficient of an i-th wind power unit at time t;
$${p}_{i , t}^{w f}$$
is predicted output of the i-th wind power unit at time t;
$${p}_{i , t}^{w}$$
is actual output of the i-th wind power unit at time t; Nₚ is a number of photovoltaic units in the dispatch region;
$${c}_{i , t}^{p}$$
is a curtailment cost coefficient of an i-th photovoltaic unit at time t;
$${P}_{i , t}^{p f}$$
is predicted output of the i-th photovoltaic unit at time t;
$${P}_{i , t}^{p}$$
is actual output of the i-th photovoltaic unit at time t; Nₑₛ is a number of electrochemical energy storage systems in the dispatch region;
$${c}_{i , t}^{e s}$$
is an operation cost per unit power of an i-th electrochemical energy storage system at time t;
$${p}_{i , t}^{es , d}$$
is a discharging power of the i-th electrochemical energy storage system at time t;
$${p}_{i , t}^{es , c}$$
is a charging power of the i-th electrochemical energy storage system at time t; Nₗ is the number of demand responses in the dispatch region;
$${c}_{i , t}^{d m}$$
is a cost coefficient of an i-th demand response at time t; and
$${p}_{i , t}^{d m}$$
is an i-th actual demand response at time t.

4. The method for zonal joint peak shaving dispatch considering a day-ahead operation security domain according to claim 3, wherein the overall constraints comprise: wind and photovoltaic safe operating range constraints, technical output upper and lower limits and ramp rate constraints of the thermal power units, energy storage system operation constraints, power balance constraints, line power flow security constraints and tie-line constraints, system positive and negative spinning reserve constraints, and demand response model constraints;
the wind and photovoltaic safe operating range constraints comprise:
$$\{ \begin{matrix}{p}_{i , t}^{w , min} \leq {p}_{i , t}^{w} \leq {p}_{i , t}^{w f} \leq {p}_{i , t}^{w , max} \\ {p}_{i , t}^{p , min} \leq {p}_{i , t}^{p} \leq {p}_{i , t}^{p f} \leq {p}_{i , t}^{p , max}\end{matrix} ;$$
wherein
$${p}_{i , t}^{w , min}$$
is minimum output of the i-th wind power unit at time t;
$${p}_{i , t}^{w , max}$$
is maximum output of the i-th wind power unit at time t;
$${p}_{i , t}^{p , min}$$
is minimum output of the i-th photovoltaic unit at time t; and
$${p}_{i , t}^{p , max}$$
is maximum output of the i-th photovoltaic unit at time t;
the technical output upper and lower limits and ramp rate constraints of the thermal power units comprise:
$${u}_{i , t}^{g} {p}_{i , t}^{g , min} \leq {p}_{i , t}^{g} \leq {u}_{i , t}^{g} {p}_{i , t}^{g , max}$$
$$\{ \begin{matrix}{p}_{i , t + 1}^{g} - {p}_{i , t}^{g} \leq {Q}_{i}^{g , up} {u}_{i , t}^{g} + {p}_{i , t + 1}^{g , min} ( {u}_{i , t + 1}^{g} - {u}_{i , t}^{g} ) + {p}_{i , t + 1}^{g , max} ( 1 - {u}_{i , t + 1}^{g} ) \\ {p}_{i , t}^{g} - {p}_{i , t + 1}^{g} \leq {Q}_{i}^{g , down} {u}_{i , t + 1}^{g} - {p}_{i , t + 1}^{g , min} ( {u}_{i , t + 1}^{g} - {u}_{i , t}^{g} ) + {p}_{i , t + 1}^{g , max} ( 1 - {u}_{i , t}^{g} )\end{matrix} ;$$
wherein
$${p}_{i , t}^{g , min}$$
is minimum output of the i-th thermal power unit at time t;
$${p}_{i , t}^{g , max}$$
is maximum output of the i-th thermal power unit at time t;
$${P}_{i , t + 1}^{g}$$
is actual output of the i-th thermal power unit at time t+1;
$${Q}_{i}^{g , up}$$
is a ramping-up power limit of the i-th thermal power unit;
$${p}_{i , t + 1}^{g , min}$$
is minimum output of the i-th thermal power unit at time t+1;
$${u}_{i , t + 1}^{g}$$
is a start-stop state variable of the i-th thermal power unit at time t+1;
$${p}_{i , t + 1}^{g , max}$$
is maximum output of the i-th thermal power unit at time t+1; and
$${Q}_{i}^{g , down}$$
is a ramping-down power limit of the i-th thermal power unit;
the energy storage system operation constraints comprise:
$$\{ \begin{matrix} & {p}_{i , t}^{es , min} \leq {p}_{i , t}^{es , c} , {p}_{i , t}^{es , d} \leq {p}_{i , t}^{es , max} \\ S o {C}_{i , t + 1}^{es} = & S o {C}_{i , t}^{es} + [ ( {η}_{i , t}^{es , c} {p}_{i , t}^{es , c} - {p}_{i , t}^{es , d} / {η}_{i , t}^{es , d} ) Δ t ] / {E}_{i}^{e s} ; \\ & S o {C}_{i , t}^{es , min} \leq S o {C}_{i , t}^{es} \leq S o {C}_{i , t}^{es , max}\end{matrix}$$
wherein
$${p}_{i , t}^{es , min}$$
is a lower power limit of the i-th electrochemical energy storage system at time t;
$${p}_{i , t}^{es , max}$$
is an upper power limit of the i-th electrochemical energy storage system at time t;
$$S o {C}_{i , t + 1}^{es}$$
is a state of charge of the i-th electrochemical energy storage system at time t+1;
$$S o {C}_{i , t}^{e s}$$
is a state of charge of the i-th electrochemical energy storage system at time t;
$${η}_{i , t}^{es , c}$$
is charging efficiency of the i-th electrochemical energy storage system at time t;
$${η}_{i , t}^{es , d}$$
is discharging efficiency of the i-th electrochemical energy storage system at time t; Δt is a t-th dispatch time period;
$${E}_{i}^{es}$$
is rated energy of the i-th electrochemical energy storage system;
$$S o {C}_{i , t}^{es , min}$$
is a low state of charge of the i-th electrochemical energy storage system at time t; and
$$S o {C}_{i , t}^{es , max}$$
is a high state of charge of the i-th electrochemical energy storage system at time t;
the power balance constraints comprise:
$${\sum }_{i = 1}^{{N}_{g}} {p}_{i , t}^{g} + {\sum }_{i = 1}^{{N}_{w}} {p}_{i , t}^{w} + {\sum }_{i = 1}^{{N}_{p}} {p}_{i , t}^{p} + {\sum }_{i = 1}^{{N}_{es}} ( {p}_{i , t}^{es , d} - {p}_{i , t}^{es , c} ) = {\sum }_{i = 1}^{{N}_{l}} ( {p}_{i , t}^{load} - {p}_{i , t}^{dm} ) + {\sum }_{j = 1}^{NT} {p}_{j , t}^{nt}$$
wherein
$${p}_{i , t}^{load}$$
is an i-th local load at time t;
$${p}_{j , t}^{nt}$$
is an outgoing load of a j-th tie-line at time t; and NT is a number of tie-lines with outgoing loads;
the line power flow security constraints and the tie-line constraints comprise:
$$- {P}_{l}^{max} \leq {p}_{l , t}^{k} \leq {P}_{l}^{max} ;$$
$$- {P}_{j , t}^{nt , max} \leq {p}_{j , t}^{nt} \leq {P}_{j , t}^{nt , max} ;$$
wherein
$${P}_{l}^{max}$$
is an upper power limit of an l-th line;
$${p}_{l , t}^{k}$$
is an actual power of the l-th line at time t;
$${P}_{j , t}^{nt , max}$$
is an upper power limit of the j-th tie-line; and
$${p}_{j , t}^{nt}$$
is an actual power of the j-th tie-line;
the system positive and negative spinning reserve constraints comprise:
$$\{ \begin{matrix}{\sum }_{i = 1}^{{N}_{g}} min \{ {p}_{i , t}^{g , max} - {p}_{i , t}^{g} , {Q}_{i}^{g , up} \} \geq {R}_{t}^{g +} \\ {\sum }_{i = 1}^{{N}_{g}} min \{ {p}_{i , t}^{g} - {p}_{i , t}^{g , min} , {Q}_{i}^{g , down} \} \geq {R}_{t}^{g -}\end{matrix}$$
$$\{ \begin{matrix}{R}_{t}^{g +} = {\sum }_{i = 1}^{{N}_{g}} {R}_{i , t}^{g +} \geq {\partial }^{l +} {\sum }_{i = 1}^{{N}_{l}} {p}_{i , t}^{load} + {\partial }^{w +} {\sum }_{i = 1}^{{N}_{w}} {p}_{i , t}^{w} + {\partial }^{p +} {\sum }_{i = 1}^{{N}_{p}} {p}_{i , t}^{p} \\ {R}_{t}^{g -} = {\sum }_{i = 1}^{{N}_{g}} {R}_{i , t}^{g +} \geq {\partial }^{l -} {\sum }_{i = 1}^{{N}_{l}} {p}_{i , t}^{load} + {\partial }^{w -} {\sum }_{i = 1}^{{N}_{w}} {p}_{i , t}^{w} + {\partial }^{p -} {\sum }_{i = 1}^{{N}_{p}} {p}_{i , t}^{p}\end{matrix}$$
wherein
$${R}_{t}^{g +}$$
is a total positive spinning reserve capacity at time t;
$${R}_{t}^{g -}$$
is a total negative spinning reserve capacity at time t; ∂^{w+} is an upward reserve coefficient for the wind power units; ∂^{p+} is an upward reserve coefficient for the photovoltaic units; ∂^{l+} is an upward reserve coefficient for the local loads; ∂^{w-} is a downward reserve coefficient for the wind power units; ∂^{p-} is a downward reserve coefficient for the photovoltaic units; and ∂^{l-} is a downward reserve coefficient for the local loads;
the demand response model constraints comprise:
$${p}_{i , min}^{dm} \leq {p}_{i , t}^{dm} \leq {k}_{i , max}^{dm} {p}_{i , max}^{load} ;$$
wherein
$${p}_{i , min}^{dm}$$
is a lower limit value of the i-th demand response;
$${p}_{i , max}^{load}$$
is a day-ahead peak value of the i-th local load; and
$${k}_{i , max}^{dm}$$
is a maximum coefficient of the i-th demand response.

5. The method for zonal joint peak shaving dispatch considering a day-ahead operation security domain according to claim 4, wherein the day-ahead operation security domain comprises:
$$Ω = \{ x \vert \begin{matrix}f ( x , y ) & = 0 \\ g ( x , y , z ) & \leq 0 \\ k ( x , y ) & \leq 0\end{matrix} \} ;$$
wherein Ω is a set of all unit operating points in a zone; x is a key decision vector corresponding to all the unit operating points in the zone during the dispatch period; z is a discrete variable of a wind-photovoltaic-thermal-energy storage system in the zone; y is a vector formed by other system variables; f(x,y)=0 is a power flow equality constraint; g(x,y,z)≤0 is a unit commitment constraint set, comprising: the wind and photovoltaic safe operating range constraints, the technical output upper and lower limits and ramp rate constraints of the thermal power units, the energy storage system operation constraints, and the demand response model constraints; and k(x,y)≤0 is a security constraint set;
the power flow equality constraint is expressed as follows:
$${\sum }_{i = 1}^{Ng , x} {p}_{i , t}^{g} + {\sum }_{i = 1}^{Nw , x} {p}_{i , t}^{w} + {\sum }_{i = 1}^{Np , x} {p}_{i , t}^{p} + {\sum }_{i = 1}^{Nes , x} ( {p}_{i , t}^{es , d} - {p}_{i , t}^{es , c} ) = {\sum }_{i = 1}^{{N}_{l , x}} ( {p}_{i , t}^{load} - {p}_{i , t}^{dm} ) + {\sum }_{j = 1}^{{NT}_{x}} {p}_{j , t}^{nt}$$
wherein N_{g,x} is the number of thermal power units in an x-th zone; N_{w,x} is the number of wind power units in the x-th zone; N_{p,x} is the number of photovoltaic units in the x-th zone; N_{es,x} is the number of electrochemical energy storage systems in the x-th zone; N_{l,x} is the number of local loads in the x-th zone; and NTₓ is the number of tie-lines in the x-th zone;
the security constraint set is expressed as follows:
$$\{ \begin{matrix}- {p}_{l , x}^{max} \leq {p}_{l , x , t}^{k} \leq {p}_{l , x}^{max} \\ - {p}_{x , j , t}^{nt , max} \leq {p}_{x , j , t}^{nt} \leq {p}_{x , j , t}^{nt , max} \\ {\sum }_{i = 1}^{{N}_{g , x}} min \{ {p}_{i , t}^{g , max} - {p}_{i , t}^{g} , {Q}_{i}^{g , up} \} \geq {R}_{t , x}^{g +} \\ {\sum }_{i = 1}^{{N}_{g , x}} min \{ {p}_{i , t}^{g} - {p}_{i , t}^{g , min} , {Q}_{i}^{g , down} \} \geq {R}_{t , x}^{g -} \\ {R}_{t , x}^{g +} \geq {\partial }^{l +} {\sum }_{i = 1}^{{N}_{l , x}} {p}_{i , t}^{load} + {\partial }^{w +} {\sum }_{i = 1}^{{N}_{w , x}} {p}_{i , t}^{w} + {\partial }^{p +} {\sum }_{i = 1}^{{N}_{p , x}} {p}_{i , t}^{p} \\ {R}_{t , x}^{g -} \geq {\partial }^{l -} {\sum }_{i = 1}^{{N}_{l , x}} {p}_{i , t}^{load} + {\partial }^{w -} {\sum }_{i = 1}^{{N}_{w , x}} {p}_{i , t}^{w} + {\partial }^{p -} {\sum }_{i = 1}^{{N}_{p , x}} {p}_{i , t}^{p}\end{matrix}$$
wherein
$${p}_{l , x , t}^{k}$$
is an actual power of an l-th line in the x-th zone at time t;
$${P}_{l , x}^{max}$$
is an upper power limit of the l-th line in the x-th zone;
$${p}_{x , j , t}^{nt}$$
is an actual power of a j-th tie-line in the x-th zone at time t;
$${P}_{x , j , t}^{nt , max}$$
is an upper power limit of the j-th tie-line in the x-th zone at time
$${R}_{t , x}^{g +}$$
is a positive spinning reserve capacity of the x-th zone at time t; and
$${R}_{t , x}^{g -}$$
is a negative spinning reserve capacity of the x-th zone at time t.

6. The method for zonal joint peak shaving dispatch considering a day-ahead operation security domain according to claim 5, wherein a calculation formula for the upward regulation capability comprises:
$${T}_{x , t}^{+} = {\sum }_{i = 1}^{{N}_{g , x}} [ min \{ {p}_{i , t}^{g , max} - {p}_{i , t}^{g} , {Q}_{i}^{g , up} \} - {R}_{i , t}^{g +} ] + {\sum }_{i = 1}^{{N}_{l , x}} [ {k}_{i , max}^{dm} {p}_{i , max}^{load} - {p}_{i , t}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es , max} - {SoC}_{i , t}^{es} ) {E}_{i}^{es} + ( {p}_{i , t}^{es , d} - {p}_{i , t}^{es , c} ) ] \}$$
a calculation formula for the downward regulation capability comprises:
$${T}_{x , t}^{-} = {\sum }_{i = 1}^{{N}_{g , x}} [ min \{ {p}_{i , t}^{g} - {p}_{i , t}^{g , min} , {Q}_{i}^{g , down} \} - {R}_{i , t}^{g -} ] + {\sum }_{i = 1}^{{N}_{l , x}} [ {p}_{i , t}^{dm} - {p}_{i , min}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es} - {SoC}_{i , t}^{es , min} ) {E}_{i}^{es} + ( {p}_{i , t}^{es , d} - {p}_{i , t}^{es , c} ) ] \}$$
wherein
$${T}_{x , t}^{+}$$
is an upward regulation capability of the x-th zone at time t; and
$${T}_{x , t}^{-}$$
is a downward regulation capability of the x-th zone at time t.

7. The method for zonal joint peak shaving dispatch considering a day-ahead operation security domain according to claim 6, wherein the peak shaving demand allocation model comprises:
$$\{ \begin{matrix}{\sum }_{j = 1}^{NT} {p}_{j , t}^{nt +} = {\sum }_{x = 1}^{{N}_{x}} {p}_{x , t}^{T} \\ - {P}_{l , x}^{a , max} \leq {\sum }_{x = 1}^{{N}_{x}} {G}_{l - x} {p}_{x , t}^{T} - {\sum }_{j = 1}^{NT} {G}_{l - j} {p}_{j , t}^{nt +} + {p}_{t}^{10} \leq {P}_{l , x}^{a , max} \\ - {P}_{j , t}^{nt , max} \leq {p}_{j , t}^{nt} + {p}_{j , t}^{nt +} \leq {P}_{j , t}^{nt , max} \\ - {T}_{x , t , f}^{-} \leq {p}_{x , t}^{T} \leq {T}_{x , t , max}^{+} or - {T}_{x , t , max}^{-} \leq {p}_{x , t}^{T} \leq {T}_{x , t , f}^{+}\end{matrix}$$
$$\{ \begin{matrix}{T}_{x , t , m}^{-} = {u}_{x , t}^{m} {T}_{x , t , f}^{-} + ( 1 - {u}_{x , t}^{m} ) {T}_{x , t , max}^{-} \\ {T}_{x , t , m}^{+} = {u}_{x , t}^{m} {T}_{x , t , max}^{+} + ( 1 - {u}_{x , t}^{m} ) {T}_{x , t , f}^{+} \\ - {T}_{x , t , m}^{-} \leq {p}_{x , t}^{T} \leq {T}_{x , t , m}^{+} \\ {\sum }_{t = 1}^{T} {u}_{x , t}^{m} ( 1 - {u}_{x , t}^{m} ) \leq {γ}_{x}^{m}\end{matrix}$$
$$min {L}_{m} = {\sum }_{t = 1}^{T} \sqrt{{\sum }_{x = 1}^{{N}_{x}} {( {p}_{x , t}^{T} )}^{2}}$$
wherein
$${p}_{j , t}^{nt +}$$
is a load demand of a newly added j-th tie-line; Nₓ is a number of zones;
$${p}_{x , t}^{T}$$
is a peak shaving demand support power of the x-th zone at time t;
$${P}_{l , x}^{a , max}$$
is an upper power limit of the l-th tie-line in the x-th zone; Gₗ₋ₓ is a power transfer distribution factor between the x-th zone and the l-th tie-line; Gₗ₋ⱼ is a power transfer distribution factor between the l-th tie-line and the j-th tie-line;
$${p}_{t}^{l 0}$$
is a power flow of the l-th line at time t under the day-ahead dispatch plan;
$${P}_{j , t}^{nt , max}$$
is an upper power limit of the j-th tie-line at time t;
$${T}_{x , t , m}^{-}$$
is a minimum dispatch capability of the x-th zone at time t;
$${u}_{x , t}^{m}$$
is a binary state variable characterizing a dispatch capability mode of the x-th zone at time t;
$${T}_{x , t , m}^{+}$$
is a maximum dispatch capability of the x-th zone at time t;
$${γ}_{x}^{m}$$
is a set threshold for a number of mode switches of the x-th zone; and Lₘ is a target value characterizing balanced peak shaving.

8. A computer device, comprising a memory, a processor, and a computer program stored in the memory and executable on the processor, wherein the computer program is executed by the processor to implement the method for zonal joint peak shaving dispatch considering a day-ahead operation security domain according to claim 1.

9. A non-transitory computer-readable storage medium, wherein the computer-readable storage medium stores a computer program, and the computer program, when executed by a processor, implements the method for zonal joint peak shaving dispatch considering a day-ahead operation security domain according to claim 1.

10. The computer device according to claim 8, wherein a process of determining the zonal plan correction model comprises:
generating zonal day-ahead dispatch plans and zonal peak shaving demands for each zone of a plurality of training regions by using a random function;
constructing a zonal day-ahead dispatch correction model for each training dispatch region based on an overall day-ahead dispatch plan of each training dispatch region and the zonal peak shaving demand of each zone;
solving the zonal day-ahead dispatch correction model of each training dispatch region by using an Eel and Grouper Optimizer (EGO) algorithm, to obtain a corrected zonal day-ahead dispatch plan for each training dispatch region;
constructing the BiGRU-Attention neural network based on a forward gated recurrent unit, a backward gated recurrent unit, and an attention mechanism; and
training the BiGRU-Attention neural network by using the zonal day-ahead dispatch plan and the zonal peak shaving demand of each zone of each training dispatch region as input, and the corrected zonal day-ahead dispatch plan of the corresponding zone as output, to obtain the zonal plan correction model.

11. The computer device according to claim 8, wherein the overall day-ahead dispatch objective function comprises:
$${C}_{total}^{ahead} = {C}_{g} + {C}_{loss} + {C}_{es} + {C}_{dm} ;$$
$$\{ \begin{matrix}{C}_{g} = {C}_{g , coal} + {C}_{g , on} + {C}_{g , rv} \\ = {\sum }_{i = 1}^{{N}_{g}} {\sum }_{t = 1}^{T} {u}_{i , t}^{g} [ {{a}_{i} ( {p}_{i , t}^{g} )}^{2} + {b}_{i} {p}_{i , t}^{g} + {c}_{i} ] + \\ {\sum }_{i = 1}^{{N}_{g}} {\sum }_{t = 1}^{T} {c}_{i , t}^{g , on} [ {u}_{i , t}^{g} ( 1 - {u}_{i , t}^{g} ) ] + {\sum }_{i = 1}^{{N}_{g}} {\sum }_{t = 1}^{T} [ {c}_{i , t}^{g , rv} ( {R}_{i , t}^{g +} + {R}_{i , t}^{g -} ) ] \\ {C}_{loss} = {\sum }_{i = 1}^{{N}_{w}} {\sum }_{t = 1}^{T} [ {c}_{i , t}^{w} ( {p}_{i , t}^{wf} - {p}_{i , t}^{w} ) ] + {\sum }_{i = 1}^{{N}_{p}} {\sum }_{t = 1}^{T} [ {c}_{i , t}^{p} ( {p}_{i , t}^{pf} - {p}_{i , t}^{p} ) ] \\ {C}_{es} = {\sum }_{i = 1}^{{N}_{es}} {\sum }_{t = 1}^{T} [ {c}_{i , t}^{es} ( {p}_{i , t}^{es , d} + {p}_{i , t}^{es , c} ) ] \\ {C}_{dm} = {\sum }_{i = 1}^{{N}_{l}} {\sum }_{t = 1}^{T} ( {c}_{i , t}^{dm} {p}_{i , t}^{dm} )\end{matrix}$$
wherein
$${C}_{total}^{ahead}$$
is a total day-ahead dispatch cost; C_{g} is a thermal power cost; Cₗₒₛₛ is a curtailment cost; Cₑₛ is an energy storage operation cost; C_{d}m is a demand response cost; C_{g,coal} is a coal consumption cost; C_{g,on} is a start-stop cost; C_{g,rv} is a spinning reserve cost; N_{g} is a number of thermal power units in a dispatch region; T is a dispatch period;
$${u}_{i , t}^{g}$$
is a start-stop state variable of an i-th thermal power unit at time t; aᵢ, bᵢ, and cᵢ are coal consumption coefficients of thermal power;
$${p}_{i , t}^{g}$$
is actual output of the i-th thermal power unit at time t;
$${c}_{i , t}^{g , on}$$
is a single start-stop cost of the i-th thermal power unit at time t;
$${c}_{i , t}^{g , rv}$$
is a spinning reserve capacity cost coefficient of the i-th thermal power unit at time t;
$${R}_{i , t}^{g +}$$
is a positive spinning reserve capacity of the i-th thermal power unit at time t;
$${R}_{i , t}^{g -}$$
is a negative spinning reserve capacity of the i-th thermal power unit at time t; N_{w} is a number of wind power units in the dispatch region;
$${c}_{i , t}^{w}$$
is a curtailment cost coefficient of an i-th wind power unit at time t;
$${p}_{i , t}^{wf}$$
is predicted output of the i-th wind power unit at time t;
$${p}_{i , t}^{w}$$
is actual output of the i-th wind power unit at time t; Nₚ is a number of photovoltaic units in the dispatch region;
$${c}_{i , t}^{p}$$
is a curtailment cost coefficient of an i-th photovoltaic unit at time t;
$${p}_{i , t}^{pf}$$
is predicted output of the i-th photovoltaic unit at time t;
$${p}_{i , t}^{p}$$
is actual output of the i-th photovoltaic unit at time t; Nₑₛ is a number of electrochemical energy storage systems in the dispatch region;
$${c}_{i , t}^{es}$$
is an operation cost per unit power of an i-th electrochemical energy storage system at time t;
$${p}_{i , t}^{es , d}$$
is a discharging power of the i-th electrochemical energy storage system at time t;
$${p}_{i , t}^{es , c}$$
is a charging power of the i-th electrochemical energy storage system at time t; Nₗ is the number of demand responses in the dispatch region;
$${c}_{i , t}^{dm}$$
is a cost coefficient of an i-th demand response at time t; and
$${p}_{i , t}^{dm}$$
is an i-th actual demand response at time t.

12. The computer device according to claim 11, wherein the overall constraints comprise: wind and photovoltaic safe operating range constraints, technical output upper and lower limits and ramp rate constraints of the thermal power units, energy storage system operation constraints, power balance constraints, line power flow security constraints and tie-line constraints, system positive and negative spinning reserve constraints, and demand response model constraints;
the wind and photovoltaic safe operating range constraints comprise:
$$\{ \begin{matrix}{p}_{i , t}^{w , min} \leq {p}_{i , t}^{w} \leq {p}_{i , t}^{wf} \leq {p}_{i , t}^{w , max} \\ {p}_{i , t}^{p , min} \leq {p}_{i , t}^{p} \leq {p}_{i , t}^{pf} \leq {p}_{i , t}^{p , max}\end{matrix} ;$$
wherein
$${p}_{i , t}^{w , min}$$
is minimum output of the i-th wind power unit at time t;
$${p}_{i , t}^{w , max}$$
is maximum output of the i-th wind power unit at time t;
$${p}_{i , t}^{p , min}$$
is minimum output of the i-th photovoltaic unit at time t; and
$${p}_{i , t}^{p , max}$$
is maximum output of the i-th photovoltaic unit at time t;
the technical output upper and lower limits and ramp rate constraints of the thermal power units comprise:
$${u}_{i , t}^{g} {p}_{i , t}^{g , min} \leq {p}_{i , t}^{g} \leq {u}_{i , t}^{g} {p}_{i , t}^{g , max} ;$$
$$\{ \begin{matrix}{p}_{i , t + 1}^{g} - {p}_{i , t}^{g} \leq {Q}_{i}^{g , up} {u}_{i , t}^{g} + {p}_{i , t + 1}^{g , min} ( {u}_{i , t + 1}^{g} - {u}_{i , t}^{g} ) + {p}_{i , t + 1}^{g , max} ( 1 - {u}_{i , t + 1}^{g} ) \\ {p}_{i , t}^{g} - {p}_{i , t + 1}^{g} \leq {Q}_{i}^{g , down} {u}_{i , t + 1}^{g} + {p}_{i , t + 1}^{g , min} ( {u}_{i , t + 1}^{g} - {u}_{i , t}^{g} ) + {p}_{i , t + 1}^{g , max} ( 1 - {u}_{i , t}^{g} )\end{matrix} ;$$
wherein
$${p}_{i , t}^{g , min}$$
is minimum output of the i-th thermal power unit at time t;
$${p}_{i , t}^{g , max}$$
is maximum output of the i-th thermal power unit at time t;
$${p}_{i , t + 1}^{g}$$
is actual output of the i-th thermal power unit at time t+1;
$${Q}_{i}^{g , up}$$
is a ramping-up power limit of the i-th thermal power unit;
$${p}_{i , t + 1}^{g , min}$$
is minimum output of the i-th thermal power unit at time t+1;
$${u}_{i , t + 1}^{g}$$
is a start-stop state variable of the i-th thermal power unit at time t+1;
$${p}_{i , t + 1}^{g , max}$$
is maximum output of the i-th thermal power unit at time t+1; and
$${Q}_{i}^{ℊ , down}$$
is a ramping-down power limit of the i-th thermal power unit;
the energy storage system operation constraints comprise:
$$\{ \begin{matrix}{p}_{i , t}^{es , min} \leq {p}_{i , t}^{es , c} , {p}_{i , t}^{es , d} \leq {p}_{i , t}^{es , max} \\ {SoC}_{i , t + 1}^{es} = {SoC}_{i , t}^{es} + [ ( {η}_{i , t}^{es , c} {p}_{i , t}^{es , c} - {p}_{i , t}^{es , d} / {p}_{i , t}^{es , d} {η}_{i , t}^{es , d} ) Δ t ] / {E}_{i}^{es} \\ {SoC}_{i , t}^{es , min} \leq {SoC}_{i , t}^{es} \leq {SoC}_{i , t}^{es , max}\end{matrix} ;$$
wherein
$${p}_{i , t}^{es , min}$$
is a lower power limit of the i-th electrochemical energy storage system at time t;
$${p}_{i , t}^{es , max}$$
is an upper power limit of the i-th electrochemical energy storage system at time t;
$${SoC}_{i , t + 1}^{es}$$
is a state of charge of the i-th electrochemical energy storage system at time t+1;
$${SoC}_{i , t}^{es}$$
is a state of charge of the i-th electrochemical energy storage system at time t;
$${η}_{i , t}^{es , c}$$
is charging efficiency of the i-th electrochemical energy storage system at time t;
$${η}_{i , t}^{es , d}$$
is discharging efficiency of the i-th electrochemical energy storage system at time t; Δt is a t-th dispatch time period;
$${E}_{i}^{e s}$$
is rated energy of the i-th electrochemical energy storage system;
$$S o {C}_{i , t}^{es , min}$$
is a low state of charge of the i-th electrochemical energy storage system at time t; and
$$S o {C}_{i , t}^{es , max}$$
is a high state of charge of the i-th electrochemical energy storage system at time t;
the power balance constraints comprise:
$${\sum }_{i = 1}^{N ℊ} {p}_{i , t}^{ℊ} + {\sum }_{i = 1}^{N w} {p}_{i , t}^{w} + {\sum }_{i = 1}^{N p} {p}_{i , t}^{p} + {\sum }_{i = 1}^{N es} ( {p}_{i , t}^{es , d} - {p}_{i , t}^{es , c} ) = {\sum }_{i = 1}^{{N}_{l}} ( {p}_{i , t}^{load} - {p}_{i , t}^{dm} ) + {\sum }_{j = 1}^{N T} {p}_{j , t}^{nt}$$
wherein
$${p}_{i , t}^{load}$$
is an i-th local load at time t;
$${p}_{j , t}^{nt}$$
is an outgoing load of a j-th tie-line at time t; and NT is a number of tie-lines with outgoing loads;
the line power flow security constraints and the tie-line constraints comprise:
$$- {P}_{l}^{max} \leq {p}_{l , t}^{k} \leq {P}_{l}^{max} ;$$
$$- {P}_{j , t}^{nt , max} \leq {p}_{j , t}^{nt} \leq {P}_{j , t}^{nt , max} ;$$
wherein
$${P}_{l}^{max}$$
is an upper power limit of an l-th line;
$${p}_{l , t}^{k}$$
is an actual power of the l-th line at time t;
$${P}_{j , t}^{nt , max}$$
an upper power limit of the j-th tie-line; and
$${p}_{j , t}^{nt}$$
is an actual power of the j-th tie-line;
the system positive and negative spinning reserve constraints comprise:
$$\{ \begin{matrix}{\sum }_{i = 1}^{{N}_{ℊ}} min \{ {p}_{i , t}^{ℊ , max} - {p}_{i , t}^{ℊ} , {Q}_{i}^{ℊ , up} \} \geq {R}_{t}^{ℊ +} \\ {\sum }_{i = 1}^{{N}_{ℊ}} min \{ {p}_{i , t}^{ℊ} - {p}_{i , t}^{ℊ , min} , {Q}_{i}^{ℊ , down} \} \geq {R}_{t}^{ℊ -}\end{matrix}$$
$$\{ \begin{matrix}{R}_{t}^{ℊ +} = {\sum }_{i = 1}^{{N}_{ℊ}} {R}_{i , t}^{ℊ +} \geq {\partial }^{l +} {\sum }_{i = 1}^{{N}_{l}} {p}_{i , t}^{l o a d} + {\partial }^{w +} {\sum }_{i = 1}^{{N}_{w}} {p}_{i , t}^{w} + {\partial }^{p +} {\sum }_{i = 1}^{{N}_{p}} {p}_{i , t}^{p} \\ {R}_{t}^{ℊ -} = {\sum }_{i = 1}^{{N}_{ℊ}} {R}_{i ,}^{ℊ -} \geq {\partial }^{l -} {\sum }_{i = 1}^{{N}_{l}} {p}_{i , t}^{l o a d} + {\partial }^{w -} {\sum }_{i = 1}^{{N}_{w}} {p}_{i , t}^{w} + {\partial }^{p -} {\sum }_{i = 1}^{{N}_{p}} {p}_{i , t}^{p}\end{matrix}$$
wherein
$${R}_{t}^{ℊ +}$$
is a total positive spinning reserve capacity at time t;
$${R}_{t}^{ℊ -}$$
is a total negative spinning reserve capacity at time t; ∂^{w+} is an upward reserve coefficient for the wind power units; ∂^{p+} is an upward reserve coefficient for the photovoltaic units; ∂^{l+} is an upward reserve coefficient for the local loads; ∂^{w-} is a downward reserve coefficient for the wind power units; ∂^{p-} is a downward reserve coefficient for the photovoltaic units; and ∂^{l-} is a downward reserve coefficient for the local loads;
the demand response model constraints comprise:
$${p}_{i , min}^{d m} \leq {p}_{i , t}^{d m} \leq {k}_{i , max}^{d m} {p}_{i , max}^{l o a d} ;$$
wherein
$${p}_{i , min}^{d m}$$
is a lower limit value of the i-th demand response;
$${p}_{i , max}^{l o a d}$$
is a day-ahead peak value of the i-th local load; and
$${k}_{i , max}^{d m}$$
is a maximum coefficient of the i-th demand response.

13. The computer device according to claim 12, wherein the day-ahead operation security domain comprises:
$$Ω = \{ x \vert \begin{matrix}f ( x , y ) = 0 \\ ℊ ( x , y , z ) \leq 0 \\ k ( x , y ) \leq 0\end{matrix} \} ;$$
wherein Ω is a set of all unit operating points in a zone; x is a key decision vector corresponding to all the unit operating points in the zone during the dispatch period; z is a discrete variable of a wind-photovoltaic-thermal-energy storage system in the zone; y is a vector formed by other system variables; f(x,y)=0 is a power flow equality constraint; g(x,y,z)≤0 is a unit commitment constraint set, comprising: the wind and photovoltaic safe operating range constraints, the technical output upper and lower limits and ramp rate constraints of the thermal power units, the energy storage system operation constraints, and the demand response model constraints; and k(x,y)≤0 is a security constraint set;
the power flow equality constraint is expressed as follows:
$${\sum }_{i = 1}^{N ℊ , x} {p}_{i , t}^{ℊ} + {\sum }_{i = 1}^{N w , x} {p}_{i , t}^{w} + {\sum }_{i = 1}^{N p , x} {p}_{i , t}^{p} + {\sum }_{i = 1}^{N es , x} ( {p}_{i , t}^{es , d} - {p}_{i , t}^{es , c} ) = {\sum }_{i = 1}^{{N}_{l , x}} ( {p}_{i , t}^{load} - {p}_{i , t}^{dm} ) + {\sum }_{j = 1}^{N {T}_{x}} {p}_{j , t}^{nt}$$
wherein N_{g,x} is the number of thermal power units in an x-th zone; N_{w,x} is the number of wind power units in the x-th zone; N_{p,x} is the number of photovoltaic units in the x-th zone; N_{es,x} is the number of electrochemical energy storage systems in the x-th zone; N_{l,x} is the number of local loads in the x-th zone; and NTₓ is the number of tie-lines in the x-th zone;
the security constraint set is expressed as follows:
$$\{ \begin{matrix}- {p}_{l , x}^{max} \leq {p}_{l , x , t}^{k} \leq {p}_{l , x}^{max} \\ - {p}_{x , j , t}^{nt , max} \leq {p}_{x , j , t}^{nt} \leq {p}_{x , j , t}^{nt , max} \\ {\sum }_{i = 1}^{{N}_{ℊ , x}} min \{ {p}_{i , t}^{ℊ , max} - {p}_{i , t}^{ℊ} , {Q}_{i}^{ℊ , up} \} \geq {R}_{t , x}^{ℊ +} \\ {\sum }_{i = 1}^{{N}_{ℊ , x}} min \{ {p}_{i , t}^{ℊ} - {p}_{i , t}^{ℊ , min} , {Q}_{i}^{ℊ , down} \} \geq {R}_{t , x}^{ℊ -} \\ {R}_{t , x}^{ℊ +} \geq {\partial }^{l +} {\sum }_{i = 1}^{{N}_{l , x}} {p}_{i , t}^{l o a d} + {\partial }^{w +} {\sum }_{i = 1}^{{N}_{w , x}} {p}_{i , t}^{w} + {\partial }^{p +} {\sum }_{i = 1}^{{N}_{p , x}} {p}_{i , t}^{p} \\ {R}_{t , x}^{ℊ -} \geq {\partial }^{l -} {\sum }_{i = 1}^{{N}_{l , x}} {p}_{i , t}^{l o a d} + {\partial }^{w -} {\sum }_{i = 1}^{{N}_{w , x}} {p}_{i , t}^{w} + {\partial }^{p -} {\sum }_{i = 1}^{{N}_{p , x}} {p}_{i , t}^{p}\end{matrix}$$
wherein
$${p}_{l , x , t}^{k}$$
is an actual power of an l-th line in the x-th zone at time t;
$${P}_{l , x}^{max}$$
is an upper power limit of the l-th line in the x-th zone;
$${p}_{x , j , t}^{nt}$$
is an actual power of a j-th tie-line in the x-th zone at time t;
$${P}_{x , j , t}^{nt , max}$$
is an upper power limit of the j-th tie-line in the x-th zone at time t;
$${R}_{t , x}^{g +}$$
is a positive spinning reserve capacity of the x-th zone at time t; and
$${R}_{t , x}^{g -}$$
is a negative spinning reserve capacity of the x-th zone at time t.

14. The computer device according to claim 13, wherein a calculation formula for the upward regulation capability comprises:
$${T}_{x , t}^{+} = \text{} {\sum }_{i = 1}^{{N}_{g , x}} [ min \{ {p}_{i , t}^{g , max} - {p}_{i , t}^{g} , {Q}_{i}^{g , u p} \} - {R}_{i , t}^{g +} ] + {\sum }_{i = 1}^{{N}_{l , x}} [ {k}_{i , max}^{d m} {p}_{i , max}^{l o a d} - {p}_{i , t}^{d m} ] + {\sum }_{i = 1}^{{N}_{es , x}} min \text{} \{ [ {p}_{i , t}^{es , max} + ( {p}_{i , t}^{es , d} - {p}_{i , t}^{e s , c} ) ] , [ \text{} ( So {C}_{i , t}^{es , max} - S o {C}_{i , t}^{e s} ) {E}_{i}^{e s} + ( {p}_{i , t}^{es , d} - {p}_{i , t}^{e s , c} ) ] \}$$
a calculation formula for the downward regulation capability comprises:
$${T}_{x , t}^{-} = \text{} {\sum }_{i = 1}^{{N}_{g , x}} [ min \{ {p}_{i , t}^{g} - {p}_{i , t}^{g , min} , {Q}_{i}^{g , d o w n} \} - {R}_{i , t}^{g -} ] + {\sum }_{i = 1}^{{N}_{l , x}} [ {p}_{i , t}^{d m} - {p}_{i , min}^{d m} ] + {\sum }_{i = 1}^{{N}_{es , x}} min \text{} \{ [ \text{} {p}_{i , t}^{es , max} + ( {p}_{i , t}^{es , d} - {p}_{i , t}^{e s , c} ) ] , [ \text{} ( So {C}_{i , t}^{e s} - S o {C}_{i , t}^{es , min} ) {E}_{i}^{e s} + ( {p}_{i , t}^{es , d} - {p}_{i , t}^{es , c} ) ] \}$$
wherein
$${T}_{x , t}^{+}$$
an upward regulation capability of the x-th zone at time t; and
$${T}_{x , t}^{-}$$
is a downward regulation capability of the x-th zone at time t.

15. The computer device according to claim 14, wherein the peak shaving demand allocation model comprises:
$$\{ \begin{matrix}{\sum }_{j = 1}^{N T} {p}_{j , t}^{nt +} = {\sum }_{x = 1}^{{N}_{x}} {p}_{x , t}^{T} \\ - {P}_{l , x}^{a , max} \leq {\sum }_{x = 1}^{{N}_{x}} {G}_{l - x} {p}_{x , t}^{T} - {\sum }_{j = 1}^{N T} {G}_{l - j} {p}_{j , t}^{nt +} + {p}_{t}^{10} \leq {P}_{l , x}^{a , max} \\ - {P}_{j , t}^{nt , max} \leq {p}_{j , t}^{nt} + {p}_{j , t}^{nt +} \leq {P}_{j , i}^{nt , max} \\ - {T}_{x , t , f}^{-} \leq {p}_{x , t}^{T} \leq {T}_{x , t , max}^{+} or - {T}_{x , t , max}^{-} \leq {p}_{x , t}^{T} \leq - {T}_{x , t , f}^{+}\end{matrix}$$
$$\{ \begin{matrix}{T}_{x , t , m}^{-} = {u}_{x , t}^{m} {T}_{x , t , f}^{-} + ( 1 - {u}_{x , t}^{m} ) {T}_{x , t , max}^{-} \\ {T}_{x , t , m}^{+} = {u}_{x , t}^{m} {T}_{x , t , max}^{+} + ( 1 - {u}_{x , t}^{m} ) {T}_{x , t , f}^{+} \\ - {T}_{x , t , m}^{-} \leq {p}_{x , t}^{T} \leq {T}_{x , t , m}^{+} \\ {\sum }_{t = 1}^{T} {u}_{x , t}^{m} ( 1 - {u}_{x , t}^{m} ) \leq {γ}_{x}^{m}\end{matrix}$$
$$min {L}_{m} = {\sum }_{t = 1}^{T} \sqrt{{\sum }_{x = 1}^{{N}_{x}} {( {p}_{x , t}^{T} )}^{2}}$$
wherein
$${p}_{j , t}^{nt +}$$
is a load demand of a newly added j-th tie-line; Nₓ is the number of zones;
$${p}_{x , t}^{T}$$
is a peak shaving demand support power of the x-th zone at time t;
$${P}_{l , x}^{a , max}$$
is an upper power limit of the l-th tie-line in the x-th zone; Gₗ₋ₓ is a power transfer distribution factor between the x-th zone and the l-th tie-line; Gₗ₋ⱼ is a power transfer distribution factor between the l-th tie-line and the j-th tie-line;
$${p}_{t}^{l 0}$$
is a power flow of the l-th line at time t under the day-ahead dispatch plan;
$${P}_{j , t}^{nt , max}$$
is an upper power limit of the j-th tie-line at time t;
$${T}_{x , t , m}^{-}$$
is a minimum dispatch capability of the x-th zone at time t;
$${u}_{x , t}^{m}$$
is a binary state variable characterizing a dispatch capability mode of the x-th zone at time t;
$${T}_{x , t , m}^{+}$$
is a maximum dispatch capability of the x-th zone at time t;
$${γ}_{x}^{m}$$
is a set threshold for a number of mode switches of the x-th zone; and Lₘ is a target value characterizing balanced peak shaving.

16. The non-transitory computer-readable storage medium according to claim 9, wherein a process of determining the zonal plan correction model comprises:
generating zonal day-ahead dispatch plans and zonal peak shaving demands for each zone of a plurality of training regions by using a random function;
constructing a zonal day-ahead dispatch correction model for each training dispatch region based on an overall day-ahead dispatch plan of each training dispatch region and the zonal peak shaving demand of each zone;
solving the zonal day-ahead dispatch correction model of each training dispatch region by using an Eel and Grouper Optimizer (EGO) algorithm, to obtain a corrected zonal day-ahead dispatch plan for each training dispatch region;
constructing the BiGRU-Attention neural network based on a forward gated recurrent unit, a backward gated recurrent unit, and an attention mechanism; and
training the BiGRU-Attention neural network by using the zonal day-ahead dispatch plan and the zonal peak shaving demand of each zone of each training dispatch region as input, and the corrected zonal day-ahead dispatch plan of the corresponding zone as output, to obtain the zonal plan correction model.

17. The non-transitory computer-readable storage medium according to claim 9, wherein the overall day-ahead dispatch objective function comprises:
$${C}_{total}^{ahead} = {C}_{g} + {C}_{loss} + {C}_{es} + {C}_{dm} ;$$
$$\{ \begin{matrix}\begin{matrix}{C}_{g} = {C}_{g , coal} + {C}_{g , on} + {C}_{g , rv} \\ = {\sum }_{i = 1}^{{N}_{g}} {\sum }_{t = 1}^{T} {u}_{i , t}^{g} [ {{a}_{i} ( {p}_{i , t}^{g} )}^{2} + {b}_{i} {p}_{i , t}^{g} + {c}_{i} ] + {\sum }_{i = 1}^{{N}_{g}} {\sum }_{t = 1}^{T} {c}_{i , t}^{g , on} [ {u}_{i , t}^{g} ( 1 - {u}_{i , t}^{g} ) ] + \\ {\sum }_{i = 1}^{{N}_{g}} {\sum }_{t = 1}^{T} [ {c}_{i , t}^{g , rv} ( {R}_{i , t}^{g +} + {R}_{i , t}^{g -} ) ]\end{matrix} \\ {C}_{loss} = {\sum }_{i = 1}^{{N}_{w}} {\sum }_{t = 1}^{T} [ {c}_{i , t}^{w} ( {p}_{i , t}^{wf} - {p}_{i , t}^{w} ) ] + {\sum }_{i = 1}^{{N}_{p}} {\sum }_{t = 1}^{T} [ {c}_{i , t}^{p} ( {p}_{i , t}^{pf} - {p}_{i , t}^{p} ) ] \\ {C}_{es} = {\sum }_{i = 1}^{{N}_{es}} {\sum }_{t = 1}^{T} [ {c}_{i , t}^{es} ( {p}_{i , t}^{es , d} + {p}_{i , t}^{es , c} ) ] \\ {C}_{dm} = {\sum }_{i = 1}^{{N}_{l}} {\sum }_{t = 1}^{T} ( {c}_{i , t}^{dm} {p}_{i , t}^{dm} )\end{matrix}$$
wherein
$${C}_{total}^{ahead}$$
is a total day-ahead dispatch cost; C_{g} is a thermal power cost; Cₗₒₛₛ is a curtailment cost; Cₑₛ is an energy storage operation cost; C_{d}m is a demand response cost; C_{g,coal} is a coal consumption cost; C_{g,on} is a start-stop cost; C_{g,rv} is a spinning reserve cost; N_{g} is a number of thermal power units in a dispatch region; T is a dispatch period;
$${u}_{i , t}^{g}$$
is a start-stop state variable of an i-th thermal power unit at time t; aᵢ, bᵢ, and cᵢ are coal consumption coefficients of thermal power;
$${p}_{i , t}^{g}$$
is actual output of the i-th thermal power unit at time t;
$${c}_{i , t}^{g , on}$$
is a single start-stop cost of the i-th thermal power unit at time t;
$${c}_{i , t}^{g , rv}$$
is a spinning reserve capacity cost coefficient of the i-th thermal power unit at time t;
$${R}_{i , t}^{g +}$$
is a positive spinning reserve capacity of the i-th thermal power unit at time t;
$${R}_{i , t}^{g -}$$
is a negative spinning reserve capacity of the i-th thermal power unit at time t; N_{w} is a number of wind power units in the dispatch region;
$${c}_{i , t}^{w}$$
is a curtailment cost coefficient of an i-th wind power unit at time t;
$${p}_{i , t}^{wf}$$
is predicted output of the i-th wind power unit at time t;
$${p}_{i , t}^{w}$$
is actual output of the i-th wind power unit at time t; Nₚ is a number of photovoltaic units in the dispatch region;
$${c}_{i , t}^{p}$$
is a curtailment cost coefficient of an i-th photovoltaic unit at time t;
$${p}_{i , t}^{pf}$$
is predicted output of the i-th photovoltaic unit at time t;
$${p}_{i , t}^{p}$$
is actual output of the i-th photovoltaic unit at time t; Nₑₛ is a number of electrochemical energy storage systems in the dispatch region;
$${c}_{i , t}^{es}$$
is an operation cost per unit power of an i-th electrochemical energy storage system at time t;
$${p}_{i , t}^{es , d}$$
is a discharging power of the i-th electrochemical energy storage system at time t;
$${p}_{i , t}^{es , c}$$
is a charging power of the i-th electrochemical energy storage system at time t; Nₗ is the number of demand responses in the dispatch region;
$${c}_{i , t}^{dm}$$
is a cost coefficient of an i-th demand response at time t; and
$${d}_{i , t}^{dm}$$
is an i-th actual demand response at time t.

18. The non-transitory computer-readable storage medium according to claim 17, wherein the overall constraints comprise: wind and photovoltaic safe operating range constraints, technical output upper and lower limits and ramp rate constraints of the thermal power units, energy storage system operation constraints, power balance constraints, line power flow security constraints and tie-line constraints, system positive and negative spinning reserve constraints, and demand response model constraints;
the wind and photovoltaic safe operating range constraints comprise:
$$\{ \begin{matrix}{p}_{i , t}^{w , min} \leq {p}_{i , t}^{w} \leq {p}_{i , t}^{wf} \leq {p}_{i , t}^{w , max} \\ {p}_{i , t}^{p , min} \leq {p}_{i , t}^{p} \leq {p}_{i , t}^{pf} \leq {p}_{i , t}^{p , max}\end{matrix} ;$$
wherein
$${p}_{i , t}^{w , min}$$
is minimum output of the i-th wind power unit at time t;
$${p}_{i , t}^{w , max}$$
is maximum output of the i-th wind power unit at time t;
$${p}_{i , t}^{p , min}$$
is minimum output of the i-th photovoltaic unit at time t; and
$${p}_{i , t}^{p , max}$$
is maximum output of the i-th photovoltaic unit at time t;
the technical output upper and lower limits and ramp rate constraints of the thermal power units comprise:
$${u}_{i , t}^{g} {p}_{i , t}^{g , min} \leq {p}_{i , t}^{g} \leq {u}_{i , t}^{g} {p}_{i , t}^{g , max} ;$$
$$\{ \begin{matrix}{p}_{i , t + 1}^{g} - {p}_{i , t}^{g} \leq {Q}_{i}^{g , up} {u}_{i , t}^{g} + {p}_{i , t + 1}^{g , min} ( {u}_{i , t + 1}^{g} - {u}_{i , t}^{g} ) + {p}_{i , t + 1}^{g , max} ( 1 - {u}_{i , t + 1}^{g} ) \\ {p}_{i , t}^{g} - {p}_{i , t + 1}^{g} \leq {Q}_{i}^{g , down} {u}_{i , t + 1}^{g} - {p}_{i , t + 1}^{g , min} ( {u}_{i , t + 1}^{g} - {u}_{i , t}^{g} ) + {p}_{i , t + 1}^{g , max} ( 1 - {u}_{i , t}^{g} )\end{matrix} ;$$
wherein
$${p}_{i , t}^{g , min}$$
is minimum output of the i-th thermal power unit at time t;
$${p}_{i , t}^{g , max}$$
is maximum output of the i-th thermal power unit at time t;
$${p}_{i , t + 1}^{g}$$
is actual output of the i-th thermal power unit at time t+1;
$${Q}_{i}^{g , up}$$
is a ramping-up power limit of the i-th thermal power unit;
$${p}_{i , t + 1}^{g , min}$$
is minimum output of the i-th thermal power unit at time t+1;
$${u}_{i , t + 1}^{g}$$
is a start-stop state variable of the i-th thermal power unit at time t+1;
$${p}_{i , t + 1}^{g , max}$$
is maximum output of the i-th thermal power unit at time t+1; and
$${Q}_{i}^{g , down}$$
is a ramping-down power limit of the i-th thermal power unit;
the energy storage system operation constraints comprise:
$$\{ \begin{matrix}{p}_{i , t}^{es , min} \leq {p}_{i , t}^{es , c} , {p}_{i , t}^{es , d} \leq {p}_{i , t}^{es , max} \\ {SoC}_{i , t + 1}^{e s} = {SoC}_{i , t}^{es} + [ ( {η}_{i , t}^{es , c} {p}_{i , t}^{es , c} - {p}_{i , t}^{es , d} / {η}_{i , t}^{es , d} ) Δ t ] / {E}_{i}^{es} ; \\ {SoC}_{i , t}^{es , min} \leq {SoC}_{i , t}^{es} \leq {SoC}_{i , t}^{es , max}\end{matrix}$$
wherein
$${p}_{i , t}^{es , min}$$
is a lower power limit of the i-th electrochemical energy storage system at time t;
$${p}_{i , t}^{es , max}$$
is an upper power limit of the i-th electrochemical energy storage system at time t;
$${SoC}_{i , t + 1}^{es}$$
is a state of charge of the i-th electrochemical energy storage system at time t+1;
$${SoC}_{i , t}^{es}$$
is a state of charge of the i-th electrochemical energy storage system at time t;
$${η}_{i , t}^{es , c}$$
is charging efficiency of the i-th electrochemical energy storage system at time t;
$${η}_{i , t}^{es , d}$$
discharging efficiency of the i-th electrochemical energy storage system at time t; Δt is a t-th dispatch time period;
$${E}_{i}^{es}$$
is rated energy of the i-th electrochemical energy storage system;
$${SoC}_{i , t}^{es , min}$$
is a low state of charge of the i-th electrochemical energy storage system at time t; and
$${SoC}_{i , t}^{es , max}$$
is a high state of charge of the i-th electrochemical energy storage system at time t;
the power balance constraints comprise:
$${\sum }_{i = 1}^{Ng} {p}_{i , t}^{g} + {\sum }_{i = 1}^{Nw} {p}_{i , t}^{w} + {\sum }_{i = 1}^{Np} {p}_{i , t}^{p} + {\sum }_{i = 1}^{Nes} ( {p}_{i , t}^{es , d} - {p}_{i , t}^{es , c} ) = {\sum }_{i = 1}^{{N}_{l}} ( {p}_{i , t}^{load} - {p}_{i , t}^{dm} ) + {\sum }_{j = 1}^{NT} {p}_{j , t}^{nt}$$
wherein
$${p}_{i , t}^{load}$$
is an i-th local load at time t;
$${p}_{j , t}^{nt}$$
is an outgoing load of a j-th tie-line at time t; and NT is a number of tie-lines with outgoing loads;
the line power flow security constraints and the tie-line constraints comprise:
$$- {P}_{l}^{max} \leq {p}_{l , t}^{k} \leq {P}_{l}^{max} ;$$
$$- {P}_{j , t}^{nt , max} \leq {p}_{j , t}^{nt} \leq {P}_{j , t}^{nt , max} ;$$
wherein
$${P}_{l}^{max}$$
is an upper power limit of an l-th line;
$${p}_{l , t}^{k}$$
is an actual power of the l-th line at time t;
$${P}_{j , t}^{nt , max}$$
is an upper power limit of the j-th tie-line; and
$${p}_{j , t}^{nt}$$
is an actual power of the j-th tie-line;
the system positive and negative spinning reserve constraints comprise:
$$\{ \begin{matrix}{\sum }_{i = 1}^{{N}_{g}} min \{ {p}_{i , t}^{g , max} - {p}_{i , t}^{g} , {Q}_{i}^{g , up} \} \geq {R}_{t}^{g +} \\ {\sum }_{i = 1}^{{N}_{g}} min \{ {p}_{i , t}^{g} - {p}_{i , t}^{g , min} , {Q}_{i}^{g , down} \} \geq {R}_{t}^{g -}\end{matrix}$$
$$\{ \begin{matrix}{R}_{t}^{g +} = {\sum }_{i = 1}^{{N}_{g}} {R}_{i , t}^{g +} \geq {\partial }^{l +} {\sum }_{i = 1}^{{N}_{l}} {p}_{i , t}^{load} + {\partial }^{w +} {\sum }_{i = 1}^{{N}_{w}} {p}_{i , t}^{w} + {\partial }^{p +} {\sum }_{i = 1}^{{N}_{p}} {p}_{i , t}^{p} \\ {R}_{t}^{g -} = {\sum }_{i = 1}^{{N}_{g}} {R}_{i , t}^{g -} \geq {\partial }^{l -} {\sum }_{i = 1}^{{N}_{l}} {p}_{i , t}^{load} + {\partial }^{w -} {\sum }_{i = 1}^{{N}_{w}} {p}_{i , t}^{w} + {\partial }^{p -} {\sum }_{i = 1}^{{N}_{p}} {p}_{i , t}^{p}\end{matrix}$$
wherein
$${R}_{t}^{g +}$$
is a total positive spinning reserve capacity at time t;
$${R}_{t}^{g -}$$
is a total negative spinning reserve capacity at time t; ∂^{w+} is an upward reserve coefficient for the wind power units; ∂^{p+} is an upward reserve coefficient for the photovoltaic units; ∂^{l+} is an upward reserve coefficient for the local loads; ∂^{w-} is a downward reserve coefficient for the wind power units; ∂^{p-} is a downward reserve coefficient for the photovoltaic units; and ∂^{l-} is a downward reserve coefficient for the local loads;
the demand response model constraints comprise:
$${p}_{i , min}^{dm} \leq {p}_{i , t}^{dm} \leq {k}_{i , max}^{dm} {p}_{i , max}^{load} ;$$
wherein
$${p}_{i , min}^{dm}$$
is a lower limit value of the i-th demand response;
$${p}_{i , max}^{load}$$
is a day-ahead peak value of the i-th local load; and
$${k}_{i , max}^{dm}$$
is a maximum coefficient of the i-th demand response.

19. The non-transitory computer-readable storage medium according to claim 18, wherein the day-ahead operation security domain comprises:
$$Ω = \{ x \vert \begin{matrix}f ( x , y ) = 0 \\ g ( x , y , z ) \leq 0 \\ k ( x , y ) \leq 0\end{matrix} \} ;$$
wherein Ω is a set of all unit operating points in a zone; x is a key decision vector corresponding to all the unit operating points in the zone during the dispatch period; z is a discrete variable of a wind-photovoltaic-thermal-energy storage system in the zone; y is a vector formed by other system variables; f(x,y)=0 is a power flow equality constraint; g(x,y,z)≤0 is a unit commitment constraint set, comprising: the wind and photovoltaic safe operating range constraints, the technical output upper and lower limits and ramp rate constraints of the thermal power units, the energy storage system operation constraints, and the demand response model constraints; and k(x,y)≤0 is a security constraint set;
the power flow equality constraint is expressed as follows:
$${\sum }_{i = 1}^{Ng , x} {p}_{i , t}^{g} + {\sum }_{i = 1}^{Nw , x} {p}_{i , t}^{w} + {\sum }_{i = 1}^{Np , x} {p}_{i , t}^{p} + {\sum }_{i = 1}^{Nes , x} ( {p}_{i , t}^{es , d} - {p}_{i , t}^{es , c} ) = {\sum }_{i = 1}^{{N}_{l , x}} ( {p}_{i , t}^{load} - {p}_{i , t}^{dm} ) + {\sum }_{j = 1}^{{NT}_{x}} {p}_{j , t}^{nt}$$
wherein N_{g,x} is the number of thermal power units in an x-th zone; N_{w,x} is the number of wind power units in the x-th zone; N_{p,x} is the number of photovoltaic units in the x-th zone; N_{es,x} is the number of electrochemical energy storage systems in the x-th zone; N_{l,x} is the number of local loads in the x-th zone; and NTₓ is the number of tie-lines in the x-th zone;
the security constraint set is expressed as follows:
$$\{ \begin{matrix}- {p}_{l , x}^{max} \leq {p}_{l , x , t}^{k} \leq {p}_{l , x}^{max} \\ - {p}_{x , j , t}^{nt , max} \leq {p}_{x , j , t}^{nt} \leq {p}_{x , j , t}^{nt , max} \\ {\sum }_{i = 1}^{{N}_{g , x}} min \{ {p}_{i , t}^{g , max} - {p}_{i , t}^{g} , {Q}_{i}^{g , up} \} \geq {R}_{t , x}^{g +} \\ {\sum }_{i = 1}^{{N}_{g , x}} min \{ {p}_{i , t}^{g} - {p}_{i , t}^{g , min} , {Q}_{i}^{g , down} \} \geq {R}_{t , x}^{g -} \\ {R}_{t , x}^{g +} \geq {\partial }^{l +} {\sum }_{i = 1}^{{N}_{l , x}} {p}_{i , t}^{load} + {\partial }^{w +} {\sum }_{i = 1}^{{N}_{w , x}} {p}_{i , t}^{w} + {\partial }^{p +} {\sum }_{i = 1}^{{N}_{p , x}} {p}_{i , t}^{p} \\ {R}_{t , x}^{g -} \geq {\partial }^{l -} {\sum }_{i = 1}^{{N}_{l , x}} {p}_{i , t}^{load} + {\partial }^{w -} {\sum }_{i = 1}^{{N}_{w , x}} {p}_{i , t}^{w} + {\partial }^{p -} {\sum }_{i = 1}^{{N}_{p , x}} {p}_{i , t}^{p}\end{matrix}$$
wherein
$${p}_{l , x , t}^{k}$$
is an actual power of an l-th line in the x-th zone at time t;
$${P}_{l , x}^{max}$$
is an upper power limit of the l-th line in the x-th zone;
$${p}_{x , j , t}^{nt}$$
is an actual power of a j-th tie-line in the x-th zone at time t;
$${p}_{x , j , t}^{nt , max}$$
is an upper power limit of the j-th tie-line in the x-th zone at time t;
$${R}_{t , x}^{g +}$$
is a positive spinning reserve capacity of the x-th zone at time t; and
$${R}_{t , x}^{g -}$$
is a negative spinning reserve capacity of the x-th zone at time t.

20. The non-transitory computer-readable storage medium according to claim 19, wherein a calculation formula for the upward regulation capability comprises:
$${T}_{x , t}^{+} = {\sum }_{i = 1}^{{N}_{g , x}} [ min \{ {p}_{i , t}^{g , max} - {p}_{i , t}^{g} , {Q}_{i}^{g , up} \} - {R}_{i , t}^{g +} ] + {\sum }_{i = 1}^{{N}_{l , x}} [ {k}_{i , max}^{dm} {p}_{i , max}^{load} - {p}_{i , t}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es , max} - {SoC}_{i , t}^{es} ) {E}_{i}^{es} + ( {p}_{i , t}^{es , d} - {p}_{i , t}^{es , c} ) ] \}$$
a calculation formula for the downward regulation capability comprises:
$${T}_{x , t}^{-} = {\sum }_{i = 1}^{{N}_{g , x}} [ min \{ {p}_{i , t}^{g} - {p}_{i , t}^{g , min} , {Q}_{i}^{g , down} \} - {R}_{i , t}^{g -} ] + {\sum }_{i = 1}^{{N}_{l , x}} [ {p}_{i , t}^{dm} - {p}_{i , min}^{dm} ] + {\sum }_{i = 1}^{{N}_{es , x}} min \{ [ {p}_{i , t}^{es , max} + ( {p}_{i , t}^{es , d} - {p}_{i , t}^{es , c} ) ] , [ ( {SoC}_{i , t}^{es} - {SoC}_{i , t}^{es , min} ) {E}_{i}^{es} + ( {p}_{i , t}^{es , d} - {p}_{i , t}^{es , c} ) ] \}$$
wherein
$${T}_{x , t}^{+}$$
is an upward regulation capability of the x-th zone at time t; and
$${T}_{x , t}^{-}$$
is a downward regulation capability of the x-th zone at time t.
